(19) United States
(12) Patent Application Publication
(10) Pub. No.: US 2023/0171046 A1
(43) Pub. Date: Jun. 1, 2023

(54) SELF-CONTAINED FEEDBACK TRANSMISSION FOR SIDELINK COMMUNICATION IN UNLICENSED SPECTRUM

(71) Applicant: QUALCOMM INCORPORATED, San Diego, CA (US)

(72) Inventors: Shuanshuan WU, San Diego, CA (US); Arthur GUBESKYS, San Diego, CA (US); Gene Wesley MARSH, San Diego, CA (US); Stelios STEFANATOS, San Diego, CA (US); Shailesh PATIL, San Diego, CA (US)

(21) Appl. No.: 17/997,621

(22) PCT Filed: May 28, 2021
(86) PCT No.: PCT/US2021/034821

§ 371 Date: Oct. 31, 2022

(30) Foreign Application Priority Data
Jun. 24, 2020 (GR) 20200100360

(51) Int. Cl. H04L 1/1829; H04W 72/20; H04L 5/00

(52) U.S. Cl. CPC H04L 1/1861; H04W 72/20; H04L 5/0053

(57) ABSTRACT

Methods, systems, and devices for wireless communications are described. A first user equipment (UE) may transmit the sidelink message to a second UE via a sidelink communications channel of an unlicensed radio frequency spectrum band. The first UE or the second UE may transmit a reservation signal to retain the sidelink communication channel for corresponding feedback for the sidelink message (e.g., while the second UE generates a feedback transmission). The second UE may transmit the feedback transmission over the sidelink communication channel.

### CROSS REFERENCE

The present application is a 371 national stage filing of International PCT Application No. PCT/US2021/034821 by WU et al. entitled “SELF-CONTAINED FEEDBACK TRANSMISSION FOR SIDELINK COMMUNICATION IN UNLICENSED SPECTRUM,” filed May 28, 2021; and claims priority to Greek Patent Application No. 20200100360 by WU et al. entitled “SELF-CONTAINED FEEDBACK TRANSMISSION FOR SIDELINK COMMUNICATION IN UNLICENSED SPECTRUM,” filed Jun. 24, 2020, each of which is assigned to the assignee hereof, and each of which is expressly incorporated by reference in its entirety herein.

### FIELD OF TECHNOLOGY

The following relates generally to wireless communications and more specifically to self-contained feedback transmission for sidelink communication in unlicensed spectrum.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

In some wireless communications systems, two or more UEs may use hybrid automatic repeat request (HARQ) feedback when attempting to communicate through sidelink communications in unlicensed spectrum. In the unlicensed spectrum, the ability for a receiving UE to transmit HARQ feedback may be subject to channel availability. In some examples, if the processing time to generate the HARQ feedback exceeds a gap threshold, the receiving UE may lose access to the channel. The UE may then perform a contention-based access procedure (e.g., a Listen-Before-Talk (LBT) procedure) in an attempt to regain access to the channel prior to transmitting HARQ feedback using the channel. In some examples, the UE may not regain access to a channel to transmit the HARQ feedback, which may result in dropped feedback transmissions or increased feedback latency, among other issues.

### SUMMARY

The described techniques relate to improved methods, systems, devices, and apparatuses that support self-contained feedback transmission for sidelink communication in unlicensed spectrum. Generally, the described techniques enable a user equipment (UE) to retain a communication channel between a data transmission and corresponding feedback in an unlicensed spectrum. For example, a first UE may transmit a sidelink message to a second UE via a sidelink communications channel of an unlicensed radio frequency spectrum band. The first UE or the second UE may transmit a reservation signal to retain the sidelink communication channel, which may reserve the sidelink communications channel between the sidelink transmission from the first UE and the corresponding feedback from the second UE. The second UE may transmit the feedback transmission over the sidelink communication channel after the reservation signal is transmitted to reserve the channel.

A method of wireless communications at a first UE is described. The method may include identifying a sidelink message scheduled for transmission to a second UE via a sidelink communications channel of an unlicensed radio frequency spectrum band, transmitting the sidelink message to the second UE via the sidelink communications channel of the unlicensed radio frequency spectrum band, transmitting, after transmitting the sidelink message, a reservation signal to reserve the sidelink communications channel of the unlicensed radio frequency spectrum band for feedback from the second UE, and monitoring the sidelink communications channel for a feedback message from the second UE after transmitting the reservation signal.

An apparatus for wireless communications at a first UE is described. The apparatus may include a processor, memory coupled with the processor, and instructions stored in the memory. The instructions may be executable by the processor to cause the apparatus to identify a sidelink message scheduled for transmission to a second UE via a sidelink communications channel of an unlicensed radio frequency spectrum band, transmit the sidelink message to the second UE via the sidelink communications channel of the unlicensed radio frequency spectrum band, transmit, after transmitting the sidelink message, a reservation signal to reserve the sidelink communications channel of the unlicensed radio frequency spectrum band for feedback from the second UE, and monitor the sidelink communications channel for a feedback message from the second UE after transmitting the reservation signal.

Another apparatus for wireless communications at a first UE is described. The apparatus may include means for identifying a sidelink message scheduled for transmission to a second UE via a sidelink communications channel of an unlicensed radio frequency spectrum band, transmitting the sidelink message to the second UE via the sidelink communications channel of the unlicensed radio frequency spectrum band, transmitting, after transmitting the sidelink message, a reservation signal to reserve the sidelink communications channel of the unlicensed radio frequency spectrum band for feedback from the second UE, and monitoring the sidelink communications channel for a feedback message from the second UE after transmitting the reservation signal.

A non-transitory computer-readable medium storing code for wireless communications at a first UE is described. The code may include instructions executable by a processor to identify a sidelink message scheduled for transmission to a second UE via a sidelink communications channel of an unlicensed radio frequency spectrum band, transmit the sidelink message to the second UE via the sidelink communications channel of the unlicensed radio frequency spectrum band, transmit, after transmitting the sidelink message, a reservation signal to reserve the sidelink communications channel of the unlicensed radio frequency spectrum band for feedback from the second UE, and monitor the sidelink communications channel for a feedback message from the second UE after transmitting the reservation signal.

In some examples of the method, apparatuses, and non-transitory computer-readable medium described herein, transmitting the reservation signal may include operations, features, means, or instructions for transmitting the reservation signal over a duration in time between the sidelink message and the feedback message.

Some examples of the method, apparatuses, and non-transitory computer-readable medium described herein may further include operations, features, means, or instructions for refraining from transmitting the reservation signal during a gap of the duration, where the gap may be less than a gap threshold corresponding to a timing in which a contention-based procedure may be performed prior to communicating over the sidelink communications channel.

In some examples of the method, apparatuses, and non-transitory computer-readable medium described herein, transmitting the reservation signal may include operations, features, means, or instructions for transmitting one or more repetitions of the sidelink message over a duration in time between the sidelink message and the feedback message.

In some examples of the method, apparatuses, and non-transitory computer-readable medium described herein, transmitting the reservation signal may include operations, features, means, or instructions for transmitting a same transport block (TB) of the sidelink message and a different redundancy version of the sidelink message over a duration in time between the sidelink message and the feedback message.

In some examples of the method, apparatuses, and non-transitory computer-readable medium described herein, transmitting the reservation signal may include operations, features, means, or instructions for transmitting a same TB of the sidelink message and a set of parity bits of the sidelink message over a duration in time between the sidelink message and the feedback message.

In some examples of the method, apparatuses, and non-transitory computer-readable medium described herein, transmitting the reservation signal may include operations, features, means, or instructions for transmitting a same TB of the sidelink message and a set of systematic bits of the sidelink message over a duration in time between the sidelink message and the feedback message.

In some examples of the method, apparatuses, and non-transitory computer-readable medium described herein, transmitting the reservation signal may include operations, features, means, or instructions for transmitting a reference signal over a duration in time between the sidelink message and the feedback message.

In some examples of the method, apparatuses, and non-transitory computer-readable medium described herein, the reference signal may be for channel state measurement, phase tracking, positioning, or a combination thereof.

In some examples of the method, apparatuses, and non-transitory computer-readable medium described herein, transmitting the reservation signal may include operations, features, means, or instructions for transmitting a dummy signal over a duration in time between the sidelink message and the feedback message.

In some examples of the method, apparatuses, and non-transitory computer-readable medium described herein, transmitting the reservation signal may include operations, features, means, or instructions for transmitting the reservation signal via a portion of a slot, or one or more slots, between the sidelink message and the feedback message.

In some examples of the method, apparatuses, and non-transitory computer-readable medium described herein, monitoring the sidelink communications channel may include operations, features, means, or instructions for receiving the feedback message from the second UE via the sidelink communications channel.

In some examples of the method, apparatuses, and non-transitory computer-readable medium described herein, receiving the feedback message may include operations, features, means, or instructions for receiving the feedback message via a slot configured for feedback, where the slot may be configured for feedback with respect to a second slot in which the sidelink message may be transmitted.

In some examples of the method, apparatuses, and non-transitory computer-readable medium described herein, transmitting the sidelink message may include operations, features, means, or instructions for transmitting an indication of the slot configured for feedback with the sidelink message or via a control message that schedules the sidelink message.

In some examples of the method, apparatuses, and non-transitory computer-readable medium described herein, transmitting the sidelink message may include operations, features, means, or instructions for transmitting multiple sidelink messages, where the feedback message may be for the multiple sidelink messages.

In some examples of the method, apparatuses, and non-transitory computer-readable medium described herein, transmitting the reservation signal may include operations, features, means, or instructions for transmitting the reservation signal using a set of frequency resources that at least partially overlap frequency resources used for the sidelink message, the feedback message, or both.

Some examples of the method, apparatuses, and non-transitory computer-readable medium described herein may further include operations, features, means, or instructions for transmitting a control message that schedules the sidelink message for transmission to the second UE.

Some examples of the method, apparatuses, and non-transitory computer-readable medium described herein may further include operations, features, means, or instructions for transmitting an indication of resources reserved for the reservation signal in the control message.

Some examples of the method, apparatuses, and non-transitory computer-readable medium described herein may further include operations, features, means, or instructions for transmitting an indication of resources reserved for the feedback message in the control message.

A method of wireless communications at a first UE is described. The method may include identifying a sidelink message scheduled for transmission by a second UE to the first UE via a sidelink communications channel of an unlicensed radio frequency spectrum band, receiving the sidelink message from the second UE via the sidelink communications channel of the unlicensed radio frequency spectrum band, communicating a reservation signal to reserve the sidelink communications channel of the unlicensed radio frequency spectrum band for feedback from the first UE, and transmitting the feedback message to the second UE via the sidelink communications channel after communication of the reservation signal.

An apparatus for wireless communications at a first UE is described. The apparatus may include a processor, memory coupled with the processor, and instructions stored in the memory. The instructions may be executable by the processor to cause the apparatus to identify a sidelink message scheduled for transmission by a second UE to the first UE via a sidelink communications channel of an unlicensed radio frequency spectrum band, receive the sidelink message from the second UE via the sidelink communications channel of the unlicensed radio frequency spectrum band, communicate a reservation signal to reserve the sidelink communications channel of the unlicensed radio frequency spectrum band for feedback from the first UE, and transmit a feedback message to the second UE via the sidelink communications channel after communication of the reservation signal.

Another apparatus for wireless communications at a first UE is described. The apparatus may include means for identifying a sidelink message scheduled for transmission by a second UE to the first UE via a sidelink communications channel of an unlicensed radio frequency spectrum band, receiving the sidelink message from the second UE via the sidelink communications channel of the unlicensed radio frequency spectrum band, communicating a reservation signal to reserve the sidelink communications channel of the unlicensed radio frequency spectrum band for feedback from the first UE, and transmitting the feedback message to the second UE via the sidelink communications channel after communication of the reservation signal.

A non-transitory computer-readable medium storing code for wireless communications at a first UE is described. The code may include instructions executable by a processor to identify a sidelink message scheduled for transmission by a second UE to the first UE via a sidelink communications channel of an unlicensed radio frequency spectrum band, receive the sidelink message from the second UE via the sidelink communications channel of the unlicensed radio frequency spectrum band, communicate a reservation signal to reserve the sidelink communications channel of the unlicensed radio frequency spectrum band for feedback from the first UE, and transmit a feedback message to the second UE via the sidelink communications channel after communication of the reservation signal.

In some examples of the method, apparatuses, and non-transitory computer-readable medium described herein, communicating the reservation signal may include operations, features, means, or instructions for transmitting the reservation signal over a duration in time between the sidelink message and the feedback message.

Some examples of the method, apparatuses, and non-transitory computer-readable medium described herein may further include operations, features, means, or instructions for refraining from transmitting the reservation signal during a gap of the duration, where the gap may be less than a gap threshold corresponding to a timing in which a contention-based procedure may be performed prior to communicating over the sidelink communications channel.

In some examples of the method, apparatuses, and non-transitory computer-readable medium described herein, transmitting the reservation signal may include operations, features, means, or instructions for transmitting control signaling to the second UE, where the control signaling includes channel state feedback information, channel sensing coordination information, or any combination thereof.

In some examples of the method, apparatuses, and non-transitory computer-readable medium described herein, transmitting the reservation signal may include operations, features, means, or instructions for transmitting a reference signal to the second UE, where the reservation signal may be a reference signal for channel state measurement, phase tracking, positioning, or any combination thereof.

In some examples of the method, apparatuses, and non-transitory computer-readable medium described herein, transmitting the reservation signal may include operations, features, means, or instructions for transmitting signaling for automatic gain control (AGC) training, where the signaling spans multiple symbols.

In some examples of the method, apparatuses, and non-transitory computer-readable medium described herein, transmitting the reservation signal may include operations, features, means, or instructions for transmitting a dummy signal to retain the sidelink communication channel.

In some examples of the method, apparatuses, and non-transitory computer-readable medium described herein, transmitting the reservation signal may include operations, features, means, or instructions for transmitting the reservation signal using a set of frequency resources that at least partially overlap frequency resources used for the sidelink message, the feedback message, or both.

In some examples of the method, apparatuses, and non-transitory computer-readable medium described herein, communicating the reservation signal may include operations, features, means, or instructions for receiving the reservation signal from the second UE, where the reservation signal may be a repetition of the sidelink message and the feedback message may be based on the repetition of the sidelink message.

In some examples of the method, apparatuses, and non-transitory computer-readable medium described herein, communicating the reservation signal may include operations, features, means, or instructions for receiving the reservation signal from the second UE, where the reservation signal may be a reference signal for channel state measurement, phase tracking, positioning, or any combination thereof.

In some examples of the method, apparatuses, and non-transitory computer-readable medium described herein, transmitting the feedback message may include operations, features, means, or instructions for transmitting the feedback message via a slot configured for feedback, where the slot may be configured for feedback with respect to a second slot in which the sidelink message may be received.

Some examples of the method, apparatuses, and non-transitory computer-readable medium described herein may further include operations, features, means, or instructions for receiving an indication of the slot configured for feedback with the sidelink message or via a control message that schedules the sidelink message.

In some examples of the method, apparatuses, and non-transitory computer-readable medium described herein, receiving the sidelink message may include operations, features, means, or instructions for receiving multiple sidelink messages, where the feedback message may be for the multiple sidelink messages.

Some examples of the method, apparatuses, and non-transitory computer-readable medium described herein may further include operations, features, means, or instructions for receiving a control message that schedules the sidelink message for reception from the second UE.

Some examples of the method, apparatuses, and non-transitory computer-readable medium described herein may further include operations, features, means, or instructions for receiving an indication of resources reserved for the reservation signal in the control message.

Some examples of the method, apparatuses, and non-transitory computer-readable medium described herein may further include operations, features, means, or instructions for receiving an indication of resources reserved for the feedback message in the control message.

### BRIEF DESCRIPTION OF THE DRAWINGS

FIG. 1 illustrates an example of a wireless communications system that supports self-contained feedback transmission for sidelink communication in unlicensed spectrum in accordance with aspects of the present disclosure.

FIG. 2 illustrates an example of a wireless communications system that supports self-contained feedback transmission for sidelink communication in unlicensed spectrum in accordance with aspects of the present disclosure.

FIGS. 3A & 3B illustrate examples of a wireless communications system that supports self-contained feedback transmission for sidelink communication in unlicensed spectrum in accordance with aspects of the present disclosure.

FIGS. 4A & 4B illustrate examples of a communications channel that supports self-contained feedback transmission for sidelink communication in unlicensed spectrum in accordance with aspects of the present disclosure.

FIGS. 5A & 5B illustrate examples of a communications channel that supports self-contained feedback transmission for sidelink communication in unlicensed spectrum in accordance with aspects of the present disclosure.

FIG. 6 illustrates an example of a process flow that supports self-contained feedback transmission for sidelink communication in unlicensed spectrum in accordance with aspects of the present disclosure.

FIG. 7 illustrates an example of a process flow that supports self-contained feedback transmission for sidelink communication in unlicensed spectrum in accordance with aspects of the present disclosure.

FIG. 8 shows a block diagram of a device that supports self-contained feedback transmission for sidelink communication in unlicensed spectrum in accordance with aspects of the present disclosure.

FIG. 9 shows a block diagram of a device that supports self-contained feedback transmission for sidelink communication in unlicensed spectrum in accordance with aspects of the present disclosure.

FIG. 10 shows a block diagram of a communications manager that supports self-contained feedback transmission for sidelink communication in unlicensed spectrum in accordance with aspects of the present disclosure.

FIG. 11 shows a diagram of a system including a device that supports self-contained feedback transmission for sidelink communication in unlicensed spectrum in accordance with aspects of the present disclosure.

FIGS. 12 through 18 show flowcharts illustrating methods that support self-contained feedback transmission for sidelink communication in unlicensed spectrum in accordance with aspects of the present disclosure.

### DETAILED DESCRIPTION

In some wireless communications systems, two or more wireless devices (e.g., a first user equipment (UE) and a second UE) may attempt to communicate using sidelink communications on an unlicensed spectrum. The first and second UEs may operate in a vehicle-to-everything (V2X) communications system and may support sidelink V2X communications. In some examples, sidelink communications such as V2X communications may utilize a channel of an unlicensed or shared spectrum which may be shared by other radio access technologies (RATs) (e.g., Wi-Fi). To communicate in the unlicensed spectrum, a wireless device may contend for access to time and frequency resources (e.g., a channel) of the unlicensed spectrum with other wireless devices which may enable a UE to determine if a channel is available for use before transmitting on the channel in the unlicensed spectrum.

A UE may determine if a channel in unlicensed spectrum is available for a transmission by performing a contention-based procedure such as a clear channel assessment (CCA) procedure or a listen-before-talk (LBT) procedure. A first UE may perform an LBT procedure prior to a transmission. The first UE may gain access to a channel and transmit a first signal such as a sidelink data transmission to a second UE using that channel. In some cases, the first UE may retain use of the channel for subsequent transmissions if the time between the first transmission and a second transmissions is less than a threshold time, which may be referred to as a channel hold threshold. In some cases, the second UE may retain use of the channel for a period of time after receiving a message. In this case, the second UE may transmit a second signal using the channel if the time between the first signal and the second signal does not exceed the channel hold threshold value. If the time between the first transmission and the second transmission exceeds the channel hold threshold value, then the UE may not retain use of the channel and the UE may perform an LBT procedure to regain access to a channel prior to transmitting a subsequent transmission. In some examples, the UE may have LBT success and regain access to the channel, but in other cases, LBT may fail and the UE may not regain access to the channel.

Hybrid automatic repeat request (HARQ) feedback may be used to increase the likelihood that data is received correctly over a communication link. HARQ feedback may include a combination of error detection (e.g., using cyclic redundancy check (CRC)), forward error correction (FEC), and retransmission (e.g., automatic repeat request (ARQ)). HARQ feedback may improve throughput at the medium access control (MAC) layer in poor radio conditions (e.g., low signal-to-noise conditions). In some examples, a UE may support same-slot HARQ feedback, where the device may provide HARQ feedback in a specific slot for data received in a previous symbol in the slot. In other cases, the device may provide HARQ feedback in a subsequent slot, or according to some other time interval.

In some cases, a transmitting UE may transmit a data packet (e.g., via a physical sidelink shared channel (PSSCH)) and expect a HARQ feedback (e.g., via a physical sidelink feedback channel (PSFCH)) from a receiving UE. In some examples, the transmitting UE may broadcast or groupcast the data packet to one or multiple UEs and expect a HARQ feedback from one or multiple receiving UEs. A receiving UE may take a period of time to decode the data transmission, generate the HARQ feedback signal, and reconfigure radio components to transmit the feedback message. In some cases, if the time delay between reception of the data transmission and transmission of the HARQ feedback exceed the channel hold threshold for retaining the channel, the receiving UE may lose access to the channel and may perform an LBT procedure to regain access to the channel prior to transmitting the HARQ feedback. In some cases, the LBT procedure may fail and the channel may not be available for use by the UE for transmission the HARQ feedback, which may result in increased feedback latency, dropped transmissions, or other issues.

According to some aspects, techniques may be used to support retaining access to a wireless channel between a data transmission and a feedback transmission (e.g., a corresponding HARQ message). For example, a reservation signal may be transmitted between the data transmission and HARQ feedback to retain the channel for HARQ feedback transmission. In some cases, the reservation signal may be used to keep the channel busy in order to prevent another device from gaining access, or reduce the likelihood that another device will gain access, of the channel through an LBT procedure or other contention-based procedure while the HARQ feedback signal is being generated and prepared for transmission.

In some examples, the transmitting UE may transmit a reservation signal to retain the channel. In some examples, the transmitting UE may begin transmitting the reservation signal to hold the channel after completing the data transmission (e.g., a PSSCH transmission). In this example, there may be no time delay or gap between the data transmission and the reservation signal to retain the channel. In some examples, the transmitting UE may begin transmitting the signal to retain the channel before the channel hold threshold time expires. In this case, there may be a gap between the data transmission and the start of the signal to retain the channel, but the gap will be shorter than the channel hold threshold.

In some cases, the receiving UE may choose whether to decode the reservation from the transmitting UE. For instance, the reservation signal to retain the channel may be a repetition of the data transmission (e.g., repetition of the PSSCH). The receiving UE may choose to decode the reservation signal in order to increase likelihood of successful decoding. In some examples, the reservation signal to retain the channel may be a reference signal transmission for channel measurements. In some examples, the reservation signal to retain the channel may be a dummy signal and the receiving UE may choose not to decode the signal.

Additionally, or alternatively, the receiving UE may transmit the reservation signal to retain the channel. The receiving UE may begin transmitting the reservation signal to retain the channel after receiving the data transmission and after some processing delay, in some cases. For instance, there may be a gap of less than the channel hold threshold between the data transmission and the start of transmission of the reservation signal by the receiving UE to retain the channel. This gap may allow the radio components of the receiving UE to transition from a receiving mode to a transmission mode.

The reservation signal transmitted by the receiving UE to retain the channel may be a control signaling transmission from the receiving UE to the transmitting UE. In some examples, the reservation signal to retain the channel may be a reference signal transmission for channel measurements or a signal transmission for automatic gain control (AGC) training. In some examples, the signal to retain the channel may be a dummy signal and the transmitting UE may determine whether to decode the reservation signal.

Aspects of the disclosure are initially described in the context of wireless communications systems. Aspects of the disclosure are further described with reference to communication channels and process flows. Aspects of the disclosure are further illustrated by and described with reference to apparatus diagrams, system diagrams, and flowcharts that relate to self-contained feedback transmission for sidelink communication in unlicensed spectrum.

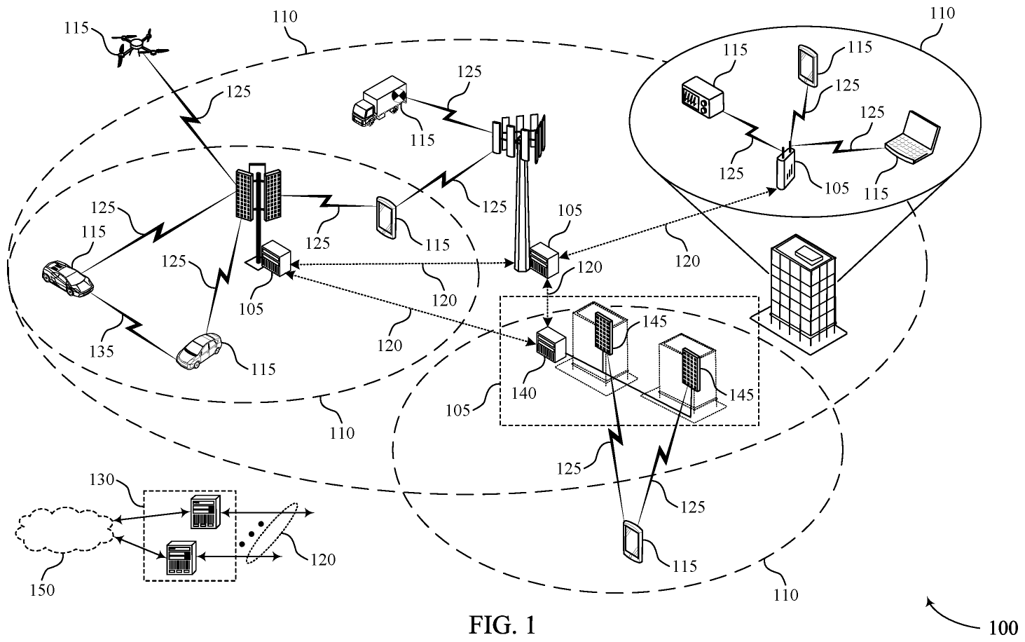

FIG. 1 illustrates an example of a wireless communications system 100 that supports self-contained feedback transmission for sidelink communication in unlicensed spectrum in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable (e.g., mission critical) communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more RATs.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (RAT) (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (e.g., of the same or a different RAT).

The communication links 125 shown in the wireless communications system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications (e.g., in a TDD mode).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a particular RAT (e.g., 1.4, 3, 5, 10, 15, 20, 40, or 80 megahertz (MHz)). Devices of the wireless communications system 100 (e.g., the base stations 105, the UEs 115, or both) may have hardware configurations that support communications over a particular carrier bandwidth or may be configurable to support communications over one of a set of carrier bandwidths. In some examples, the wireless communications system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

Each base station 105 may provide communication coverage via one or more cells, for example a macro cell, a small cell, a hot spot, or other types of cells, or any combination thereof. The term “cell” may refer to a logical communication entity used for communication with a base station 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of the base station 105. For example, a cell may be or include a building, a subset of a building, or exterior spaces between or overlapping with geographic coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered base station 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A base station 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may support synchronous or asynchronous operation. For synchronous operation, the base stations 105 may have similar frame timings, and transmissions from different base stations 105 may be approximately aligned in time. For asynchronous operation, the base stations 105 may have different frame timings, and transmissions from different base stations 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC) or mission critical communications. The UEs 115 may be designed to support ultra-reliable, low-latency, or critical functions (e.g., mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

In some systems, the D2D communication link 135 may be an example of a communication channel, such as a sidelink communication channel, between vehicles (e.g., UEs 115). In some examples, vehicles may communicate using V2X communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., base stations 105) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to the network operators IP services 150. The network operators IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 MHz to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed radio frequency spectrum bands. For example, the wireless communications system 100 may employ License Assisted Access (LAA), LTE-Unlicensed (LTE-U) RAT, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally, or alternatively, an antenna panel may support radio frequency beamforming for a signal transmitted via an antenna port.

The base stations 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105 in different directions and may report to the base station 105 an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A MAC layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. HARQ feedback is one technique for increasing the likelihood that data is received correctly over a communication link 125. HARQ may include a combination of error detection (e.g., using a CRC), FEC, and retransmission (e.g., ARQ). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

Wireless communications system 100 may support techniques to enable a UE 115 to retain access to a wireless channel in an unlicensed or shared radio frequency spectrum band for sidelink communications, such as in V2X or other systems. For example, a UE 115 may retain access to an unlicensed channel between transmission of a data message (e.g., a PSSCH) and a corresponding feedback message (e.g., PSFCH) from another UE 115. In some cases, a reservation signal may be transmitted by the UE 115 transmitting the data message (e.g., after the transmitting UE 115 transmits the data message) or may be transmitted by the UE 115 receiving the data message (e.g., prior to the receiving UE 115 transmitting the HARQ feedback message). In either case, the reservation signal may be transmitted to retain the channel (e.g., an unlicensed or shared channel) between the data transmission and the corresponding HARQ feedback message and may include control signaling, a reference signal (e.g., for channel measurements), a dummy signal, a transport block (TB) repetition, among others.

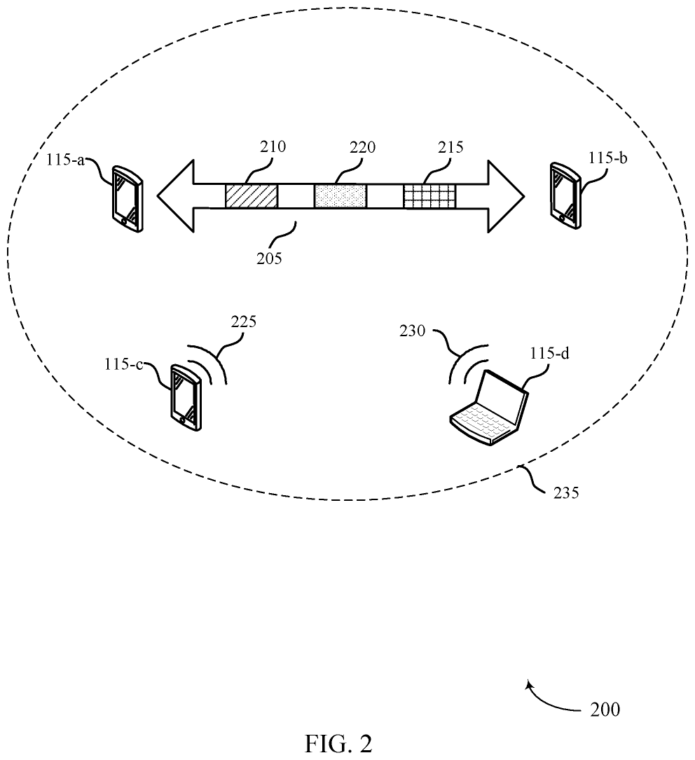

FIG. 2 illustrates an example of a wireless communications system 200 that supports self-contained feedback transmission for sidelink communication in unlicensed spectrum in accordance with aspects of the present disclosure. In some examples, wireless communications system 200 may implement aspects of wireless communications system 100. Wireless communications system 200 may include UE 115-a, UE 115-b, UE 115-c, and UE 115-d, which may be examples of corresponding UEs 115 as described with reference to FIG. 1.

In some examples, UE 115-a may attempt to transmit data transmission 210 to UE 115-b on communication channel 205 through sidelink communications. Communication channel 205 may be in unlicensed spectrum (or other shared spectrum). For communications in unlicensed spectrum, UE 115-a and UE 115-b may compete for communication resources with other wireless devices communicating in unlicensed in coverage area 235. For example, UE 115-c and UE 115-d may be wireless communication devices operating in unlicensed spectrum within coverage area 235 and in some cases, each of UE 115-a, UE 115-b, UE 115-c, and UE 115-d may support V2X communications, Wi-Fi communications, or both.

In some cases, UE 115-c and UE 115-d may compete for wireless communication resources with UE 115-a and UE 115-b. UE 115-c may operate using the same RAT as UE 115-a and UE 115-b. UE 115-c transmissions 225 may be intra-RAT interference for communications between UE 115-a and UE 115-b. UE 115-d may operate using a different RAT than UE 115-a and UE 115-b (e.g., Wi-Fi). UE 115-d transmissions 230 may be inter-RAT interference for communications between UE 115-a and UE 115-b.

Before transmitting data transmission 210 on communication channel 205, UE 115-a may determine if communication channel 205 is available for a transmission by performing a CCA such as an LBT procedure. UE 115-a may perform an LBT procedure prior to transmitting data transmission 210. If UE 115-a has LBT success, UE 115-a may transmit data transmission 210 to UE 115-b using communication channel 205.

In some cases, UE 115-a and UE 115-b may support HARQ feedback. HARQ feedback may increase the likelihood that data is received correctly over a communication channel 205. In some cases, UE 115-b may generate a feedback transmission 215 in response to data transmission 210, where feedback transmission 215 may be a HARQ feedback transmission. After receiving data transmission 210, UE 115-b may take a period of time to decode data transmission 210 and generate feedback transmission 215. For example, if UE 115-b receives data transmission 210 in slot n and HARQ feedback processing time (e.g., data channel decoding and HARQ signal generation) time takes k slots, UE 115-b may not be able to transmit feedback transmission 215 earlier than slot n+k.

In some examples, reservation signal 220 may be transmitted between data transmission 210 and feedback transmission 215 in order to retain communication channel 205 for transmission of feedback transmission 215. Reservation signal 220 may be transmitted such that there are no gaps between transmissions on communication channel 205 with durations that exceed a gap threshold (e.g., 16 μs).

In some examples, UE 115-b may retain access to communication channel in order to transmit feedback transmission 215 to UE 115-a in response to data transmission 210. UE 115-b may not perform LBT to regain access to communication channel 205 to send feedback transmission 215 to UE 115-a. Reservation signal 220 may prevent other wireless devices operating in unlicensed spectrum in coverage area 235, such as UE 115-c and UE 115-d, or devices using other technologies, from gaining access to communication channel 205 between data transmission 210 and feedback transmission 215.

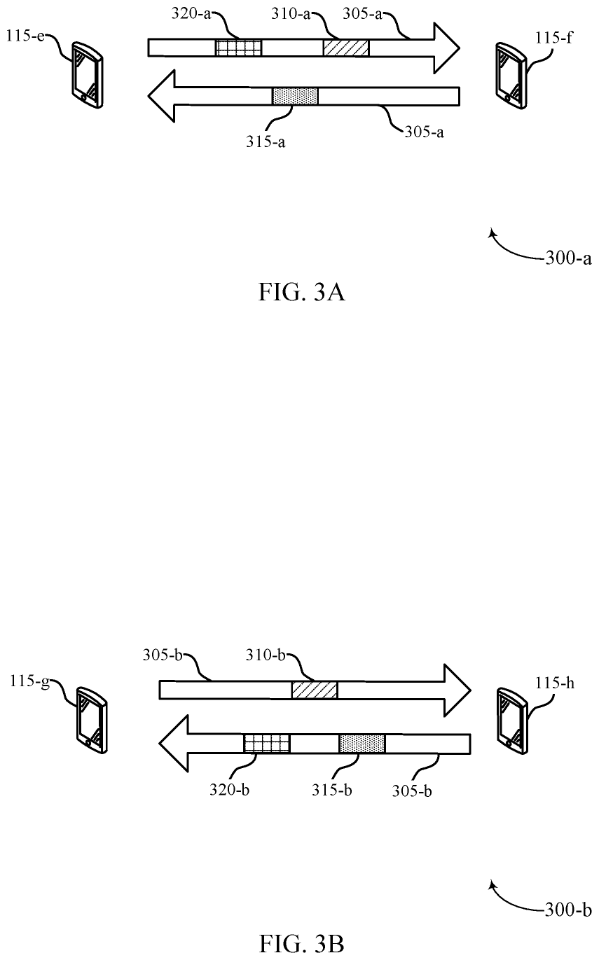

FIGS. 3A and 3B illustrate examples of a wireless communications systems 300 that supports self-contained feedback transmission for sidelink communication in unlicensed spectrum in accordance with aspects of the present disclosure. In some examples, wireless communications systems 300 may implement aspects of wireless communications systems 100 or 200.

FIG. 3A illustrates an example wireless communications system 300-a that supports reservation signal transmission between a data transmission and a feedback transmission to retain use of a communication channel 305-a. In wireless communications system 300-a, the reservation signal is transmitted by the transmitting UE. For instance, UE 115-e may transmit data transmission 310-a to UE 115-f After the data transmission 310-a, UE 115-e may transmit reservation signal 320-a. In some examples, there may be no time gap between the end of data transmission 310-a and the beginning of reservation signal 320-a. In some examples, the time gap between the end of data transmission 310-a and the beginning of reservation signal 320-a may be less than a gap threshold (e.g., 16 μs).

In some examples, UE 115-e may transmit reservation signal 320-a until the beginning of feedback transmission 315-a. In some examples, there may be no gap between the end of the reservation signal 320-a and the beginning of the feedback transmission 315-a. In some examples, there may be a time gap between the end of the reservation signal 320-a and the beginning of the feedback transmission 315-a, where the time gap is less than a gap threshold. The time gap may be configured based on the time UE 115-e may use to transition radio components from a transmission mode to a reception mode.

Reservation signal 320-a may be any signal. In some examples, reservation signal 320-a may be any signal transmitted with sufficient power to prevent LBT success on that channel by other wireless devices operating within the coverage area or a vicinity of UE 115-e and UE 115-f. In some examples, reservation signal 320-a may be a dummy signal. In some examples, reservation signal 320-a may be a sub-band signal, where the reservation signal 320-a is transmitted over a portion of the frequency resources of communication channel 305-a. In some examples, reservation signal 320-a may be transmitted over the same frequency resources that feedback transmission 315-a is transmitted by UE 115-f In some examples, reservation signal 320-a may be transmitted in the same frequency resources as the data transmission 310-a that is transmitted by UE 115-e.

In some examples, reservation signal 320-a may be one or more repetitions of data transmission 310-a. In some examples, the reservation signal 320-a may carry the same TB as the data transmission 310-a but with a different redundancy version. In some examples, the reservation signal 320-a may carry the same TB but with systematic bits or parity bits of data transmission 310-a. In some cases, the reservation signal may be a repetition of part or all OFDM symbols of the data transmission 310-a.

In some examples, when the reservation signal 320-a is a repetition of data transmission 310-a, UE 115-f may decode the reservation signal 320-a and use the decoded reservation signal 320-a for decoding data transmission 310-a. The determination to decode reservation signal 320-a may depend on the capabilities of UE 115-f In some examples, UE 115-f may decode the reservation signal 320-a and use the decoded reservation signal 320-a to generate feedback. In other examples, UE 115-f may determine not to decode the reservation signal. In this case, UE 115-f may not use the data contained in the reservation signal to generate feedback.

In some examples, reservation signal 320-a may be a reference signal transmission. The reference signal may enable additional channel measurements such as channel state information (CSI) or channel quality measurements. For example, the reference signal for reservation signal 320-a may be used for measurement including but not limited to channel state measurement, phase tracking, and positioning.

In some cases, reservation signal 320-a may be a signal transmission for AGC training, and the AGC training signal may occupy one or more symbols to serve as the reservation signal 320-a.

FIG. 3B illustrates an example wireless communications system 300-b that supports transmission of a reservation signal between a data transmission and a feedback transmission to retain use of a communication channel 305-a. In FIG. 3B, the reservation signal is transmitted by the receiving UE. For instance, UE 115-g may transmit data transmission 310-b to UE 115-h. After the data transmission 310-b, UE 115-h may transmit reservation signal 320-b. In some examples, there may be no time gap between the end of data transmission 310-b and the beginning of reservation signal 320-b. In some examples, the time gap between the end of data transmission 310-b and the beginning of reservation signal 320-b may be less than a gap threshold (e.g., 16 μs). The time gap may be configured based on the time UE 115-h may use to transition radio components from a transmission mode to a reception mode.

In some examples, UE 115-h may transmit reservation signal 320-b until the beginning of feedback transmission 315-b. In some examples, there may be no gap between the end of the reservation signal 320-b and the beginning of the feedback transmission 315-b. In some examples, there may be a time gap between the end of the reservation signal 320-a and the beginning of the feedback transmission 315-a, where the time gap is less than a gap threshold. The time gap may be configured based on the time UE 115-g may use to transition radio components from a transmission mode to a reception mode.

Reservation signal 320-b may be any signal. In some examples, reservation signal 320-b may be any signal transmitted with sufficient power to prevent LBT success on that channel by any other wireless devices operating within the coverage area or in the vicinity of UE 115-g and UE 115-h. In some examples, reservation signal 320-b may be a dummy signal. In some examples, reservation signal 320-b may be a sub-band signal, where the reservation signal 320-b is transmitted over a portion of the frequency resources of communication channel 305-b. In some examples, reservation signal 320-b may be transmitted in the same frequency resources that feedback transmission 315-b is transmitted by UE 115-h. In some examples, reservation signal 320-b may be transmitted in the same frequency resources as the data transmission 310-b transmitted by UE 115-g.

In some examples, reservation signal 320-b may be a control signaling transmission from UE 115-h to UE 115-g. In some examples, the control signaling may be lower layer signaling or upper layer signaling, such as channel state feedback or channel sensing coordination information, among others. In this case, processing of the control signaling at a UE 115-h may be independent of the data transmission 310-b decoding. For example, the control signaling carrier channel state feedback, which may be estimated from CSI-RSs transmitted by UE 115-g, and the CSI-RS may be in early location within the data transmission 310-b resource such that UE 115-h has sufficient time to process it.

In some examples, reservation signal 320-b may be a reference signal transmission. The reference signal transmission may be configured to allow additional measurements such as channel measurements or other quality measurements. For examples, the reference signal transmission for reservation signal 320-b may be used for measurements including but not limited to channel state measurement, phase tracking, and positioning.

In some examples, reservation signal 320-b may be a signal transmission for AGC training. In some cases, the AGC training signal may occupy multiple symbols and may also serve as the reservation signal 320-b.

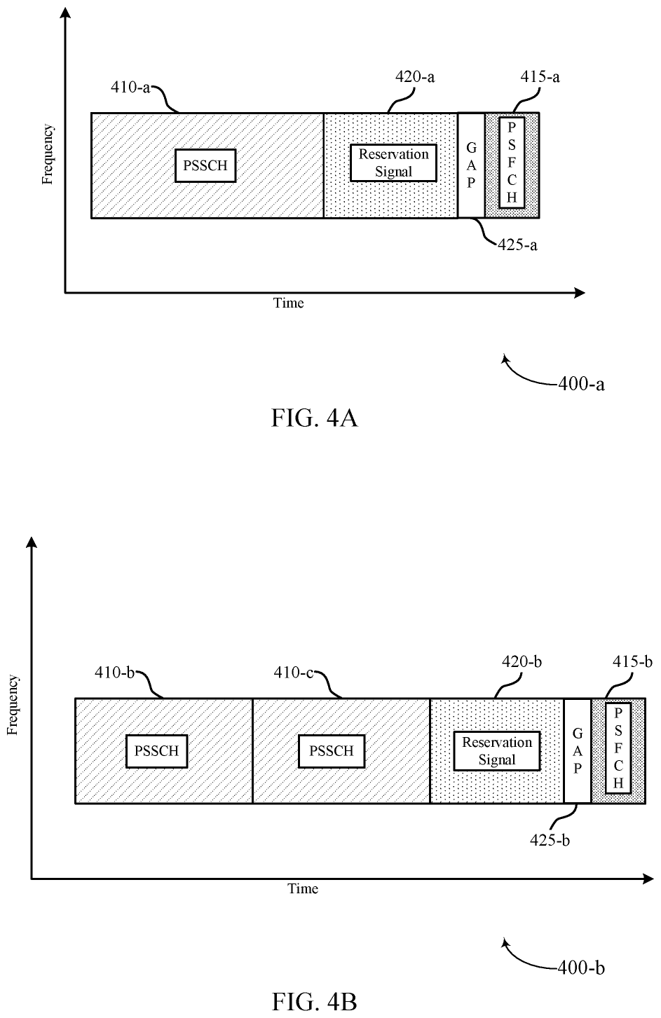

FIGS. 4A and 4B illustrate examples of a communications channel 400 that supports self-contained feedback transmission for sidelink communication in unlicensed spectrum in accordance with aspects of the present disclosure. In some examples, communications channel 400 may implement aspects of wireless communications systems 100, 200, or 300.

FIG. 4A illustrates an example of transmitting a reservation signal between a data transmission and a feedback transmission to retain use of a communication channel 400-a where the reservation signal is transmitted by the transmitting UE. In this example, a transmitting UE may transmit a data transmission 410-a. The data transmission 410-a may be a PSSCH. The transmitting UE may also transmit reservation signal 420-a. A receiving UE may transmit a feedback transmission 415-a in response to data transmission 410-a. The feedback transmission 415-a may be a PSFCH. The reservation signal 420-a may end before the feedback transmission begins, which may form a gap 425-a.

In some examples, resources for feedback transmission 415-a may be pre-configured in a periodic manner. For example, one slot may be pre-configured as a HARQ feedback slot for feedback transmission 415-a in every N slots, where N may be any number of slots such as but not limited to 2 slots, 3 slots, or 4 slots. In some examples, the reservation signal 420-a may be within the pre-configured feedback slot. For example, if N=3, and slot n, n+3, and n+6 are HARQ feedback slots, then a transmission UE may transmit a PSSCH in slot n+1 and n+2 and expect PSFCH in slot n+3.

In some examples, there may not be dedicated pre-configured slots for HARQ feedback transmission. In some examples, HARQ feedback transmission slot is determined from a pre-determined HARQ timeline, where for a data transmission 410-a in slot n, the feedback transmission 415-a is transmitted in slot n+k, where k has a pre-defined value such as an integer value of 1, 2, 3, etc.

For example, if k has a value of 1 slot, feedback transmission 415-a for a data transmission 410-a in the current slot will be sent in the next slot. In this example, the feedback transmission 415-a may occupy the last few OFDM symbols in slot n+1 and the transmitting UE may transmit the reservation signal 420-a in the first part of slot n+1. In this example, the duration of the reservation signal may be less than one slot.

In another example, if k has a value of 2 slots, feedback transmission 415-a for data transmission 410-a in current slot n will be sent in slot n+2. In this example, the feedback transmission 415-a may occupy the last few OFDM symbols in slot n+2 and the transmitting UE may transmit the reservation signal 420-a in slot n+1 and the first part of slot n+2. In this example, the duration of the reservation signal may be more than one slot.

In some examples, the transmitting UE may indicate a timeline for transmitting feedback transmission 415-a in sidelink control information. In this example, the transmitting UE may transmit the reservation signal until at least the gap threshold before the feedback transmission 415-a is scheduled to begin.

In some examples, there may be no time between the end of the reservation signal 420-a and the beginning of the feedback transmission 415-a. In this example the duration of the gap 425-a is zero. In some examples, the duration of the gap 425-a may be non-zero and may have a pre-determined value. This pre-determined value may be associated with the time a UE takes to reconfigure radio components from a receiving mode to a transmission mode. The duration of the gap 425-a may be limited by the gap threshold to reperform LBT. The duration of the gap 425 may be for example 16 μs.

FIG. 4B illustrates an example of transmitting a reservation signal between a data transmission and a feedback transmission to retain use of a communication channel 400-b where the reservation signal is transmitted by the transmitting UE. In this example, a transmitting UE may transmit a data transmission 410-b and a data transmission 410-c in multiple consecutive slots. The data transmission 410-b and data transmission 410-c may be a PSSCH. The transmitting UE may also transmit reservation signal 420-b. A receiving UE may transmit a feedback transmission 415-b in response to data transmission 410-b and data transmission 410-c. The feedback transmission 415-b may be a PSFCH. The reservation signal 420-b may end before the feedback transmission begins, which may form a gap 425-b.

In some examples, a transmitting UE may transmit a multiple data transmission in multiple consecutive slots. For example, a transmitting UE may transmit a data transmission 410-b and a second data transmission in 410-c in multiple consecutive slots. The transmitting UE may expect HARQ feedback for data transmission 410-b and data transmission 410-c in a subsequent slot. The transmitting UE may expect HARQ feedback for data transmission 410-b and data transmission 410-c in a single feedback transmission 415-b. In some examples, a timeline for feedback is determined based on the last slot of the multi-data transmission, such as the slot containing data transmission 410-c.

In some examples, the receiving UE may determine the slot to transmit feedback transmission 415-b based off of the end of the last data transmission in the series of multiple data transmissions in multiple consecutive slots. In some examples, there may be a single HARQ feedback, for repetition of the same packet, transmitted in the feedback slot for feedback transmission 415-b. In some examples, there may be multiple HARQ feedback messages multiplex in the feedback transmission 415-b, to acknowledge the transmission of data packets in the multiple consecutive slots.

In some examples, resources for feedback transmission 415-b may be pre-configured in a periodic manner. For example, one slot may be pre-configured as a HARQ feedback slot for feedback transmission 415-b in every N slots, where N may be any number of slots such as but not limited to 2 slots, 3 slots, or 4 slots. In some examples, the reservation signal 420-b may be within the pre-configured feedback slot. For example, if N=3, and slot n, n+3, and n+6 are HARQ feedback slots, then a transmission UE may transmit a PSSCH in slot n+1 and n+2 and expect PSFCH in slot n+3. In this example, the feedback transmission 415-b may provide HARQ feedback for all of the data transmissions since the previous HARQ feedback slot.

In some examples, there may not be dedicated pre-configured slots for HARQ feedback transmission. In some examples, HARQ feedback transmission slot is determined from a pre-determined HARQ timeline, where for a series of data transmissions (e.g., data transmission 410-b and data transmission 410-c) ending in slot n, the feedback transmission 415-b for the series of data transmissions is transmitted in slot n+k, where k has a pre-defined value.

For example, if k has a value of 1 slot, feedback transmission 415-b for a series of data transmissions ending in slot n will be sent in the next slot following the end of data transmissions. In this example, the feedback transmission 415-b may occupy the last few OFDM symbols in slot n+1 and the transmitting UE may transmit the reservation signal 420-b in the first part of slot n+1. In this example, the duration of the reservation signal may be less than one slot.

In another example, if k has a value of 2 slots, feedback transmission 415-b for data transmission 410-b and data transmission 410-c ending in current slot n will be sent in slot n+2. In this example, the feedback transmission 415-b may occupy the last few OFDM symbols in slot n+2 and the transmitting UE may transmit the reservation signal 420-b in slot n+1 and the first part of slot n+2. In this example, the duration of the reservation signal may be more than one slot.

In some examples, the transmitting UE may indicate a timeline for transmitting feedback transmission 415-b in sidelink control information. In this example, the transmitting UE may transmit the reservation signal until at least the gap threshold before the feedback transmission 415-b is scheduled to begin.

In some examples, there may be no time between the end of the reservation signal 420-b and the beginning of the feedback transmission 415-b. In this example the duration of the gap 425-b is zero. In some examples, the duration of the gap 425-b may be non-zero and may have a pre-determined value. This pre-determined value may be associated with the time a UE takes to reconfigure radio components from a receiving mode to a transmission mode. The duration of the gap 425-b may be limited by the gap threshold to reperform LBT. The duration of the gap 425-b may be for example 16 μs.

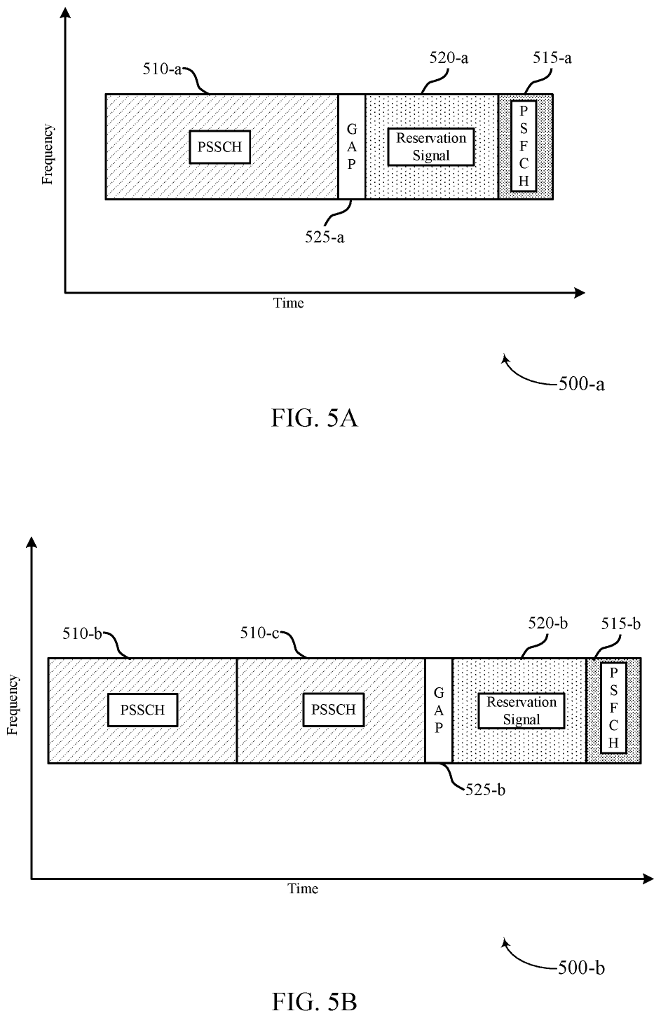

FIGS. 5A and 5B illustrate examples of a communications channel 500 that supports self-contained feedback transmission for sidelink communication in unlicensed spectrum in accordance with aspects of the present disclosure. In some examples, communications channel 500 may implement aspects of wireless communications systems 100, 200, or 300.

FIG. 5A illustrates an example of transmitting a reservation signal between a data transmission and a feedback transmission to retain use of a communication channel 500-a where the reservation signal is transmitted by the receiving UE. In this example, a transmitting UE may transmit a data transmission 510-a. The data transmission 510-a may be a PSSCH. The receiving UE may transmit reservation signal 520-a. A receiving UE may also transmit a feedback transmission 515-a in response to data transmission 510-a. The feedback transmission 515-a may be a PSFCH. The data transmission 510-a may end before the reservation signal 520-a begins, which may form a gap 525-a.

In some examples, resources for feedback transmission 515-a may be pre-configured in a periodic manner. For example, one slot may be pre-configured as a HARQ feedback slot for feedback transmission 515-a in every N slots, where N may be any number of slots such as but not limited to 2 slots, 3 slots, or 4 slots. In some examples, the reservation signal 520-a may be within the pre-configured feedback slot. For example, if N=3, and slot n, n+3, and n+6 are HARQ feedback slots, then a transmission UE may transmit a PSSCH in slot n+1 and n+2 and expect PSFCH in slot n+3.

In some examples, there may not be dedicated pre-configured slots for HARQ feedback transmission. In some examples, HARQ feedback transmission slot is determined from a pre-determined HARQ timeline, where for a data transmission 510-a in slot n, the feedback transmission 515-a is transmitted in slot n+k, where k has a pre-defined value.

For example, if k has a value of 1 slot, feedback transmission 515-a for a data transmission 510-a in the current slot will be sent in the next slot. In this example, the feedback transmission 515-a may occupy the last few OFDM symbols in slot n+1 and the receiving UE may transmit the reservation signal 520-a in the first part of slot n+1. In this example, the duration of the reservation signal may be less than one slot.

In another example, if k has a value of 2 slots, feedback transmission 515-a for data transmission 510-a in current slot n will be sent in slot n+2. In this example, the feedback transmission 515-a may occupy the last few OFDM symbols in slot n+2 and the receiving UE may transmit the reservation signal 520-a in slot n+1 and the first part of slot n+2. In this example, the duration of the reservation signal may be more than one slot.

In some examples, the transmitting UE may indicate a timeline for transmitting feedback transmission 515-a in sidelink control information. In this example, the receiving UE may transmit the reservation signal until at least the gap threshold before the feedback transmission 515-a is scheduled to begin.

In some examples, there may be no time between the end of the data transmission 510-a and the beginning of the reservation signal 520-a. In this example, the duration of the gap 525-a may be zero. In some examples, the duration of the gap 525-a may be non-zero and may have a pre-determined value. This pre-determined value may be associated with the time a UE takes to reconfigure radio components from a receiving mode to a transmission mode. The duration of the gap 525-a may be limited by the gap threshold to reperform LBT. The duration of the gap 525 may be for example 16 μs.

FIG. 5B illustrates an example of transmitting a reservation signal between a data transmission and a feedback transmission to retain use of a communication channel 500-b where the reservation signal is transmitted by the receiving UE. In this example, a transmitting UE may transmit a data transmission 510-b and a data transmission 510-c in multiple consecutive slots. The data transmission 510-b and data transmission 510-c may be a PSSCH. The receiving UE may transmit reservation signal 520-b. A receiving UE may also transmit a feedback transmission 515-b in response to data transmission 510-b and data transmission 510-c. The feedback transmission 515-b may be a PSFCH. The reservation signal 520-b may end before the feedback transmission begins, which may form a gap 525-b.

In some examples, a transmitting UE may transmit a multiple data transmission in multiple consecutive slots. For example, a transmitting UE may transmit a data transmission 510-b and a second data transmission in 510-c in multiple consecutive slots. The transmitting UE may expect HARQ feedback for data transmission 510-b and data transmission 510-c in a subsequent slot. The transmitting UE may expect HARQ feedback for data transmission 510-b and data transmission 510-c in a single feedback transmission 515-b.

In some examples, the receiving UE may determine the slot to transmit feedback transmission 515-b based on the end of the last data transmission in the series of multiple data transmissions in multiple consecutive slots. In some examples, there may be a single HARQ feedback, for repetition of the same packet, transmitted in the feedback slot for feedback transmission 515-b. In some examples, there may be multiple HARQ feedback messages multiplex in the feedback transmission 515-b, to acknowledge the transmission of data packets in the multiple consecutive slots.

In some examples, resources for feedback transmission 515-b may be pre-configured in a periodic manner. For example, one slot may be pre-configured as a HARQ feedback slot for feedback transmission 515-b in every N slots, where N may be any number of slots such as but not limited to 2 slots, 3 slots, or 4 slots. In some examples, the reservation signal 520-b may be within the pre-configured feedback slot. For example, if N=3, and slot n, n+3, and n+6 are HARQ feedback slots, then a transmission UE may transmit a PSSCH in slot n+1 and n+2 and expect PSFCH in slot n+3. In this example, the feedback transmission 515-b may provide HARQ feedback for all of the data transmissions since the previous HARQ feedback slot.

In some examples, there may not be dedicated pre-configured slots for HARQ feedback transmission. In some examples, HARQ feedback transmission slot is determined from a pre-determined HARQ timeline, where for a series of data transmissions (e.g., data transmission 510-b and data transmission 510-c) ending in slot n, the feedback transmission 515-b for the series of data transmissions is transmitted in slot n+k, where k has a pre-determined value.

For example, if k has a value of 1 slot, feedback transmission 515-b for a series of data transmissions ending in slot n will be sent in the next slot following the end of data transmissions. In this example, the feedback transmission 515-b may occupy the last few OFDM symbols in slot n+1 and the receiving UE may transmit the reservation signal 520-b in the first part of slot n+1. In this example, the duration of the reservation signal may be less than one slot.

In another example, if k has a value of 2 slots, feedback transmission 515-b for data transmission 510-b and data transmission 510-c ending in current slot n will be sent in slot n+2. In this example, the feedback transmission 515-b may occupy the last few OFDM symbols in slot n+2 and the receiving UE may transmit the reservation signal 520-b in slot n+1 and the first part of slot n+2. In this example, the duration of the reservation signal may be more than one slot.

In some examples, the transmitting UE may indicate a timeline for transmitting feedback transmission 515-b in sidelink control information. In this example, the receiving UE may transmit the reservation signal until at least the gap threshold before the feedback transmission 515-b is scheduled to begin.

In some examples, there may be no time between the end of the data transmission 520-c and the beginning of the reservation signal 520-b. In this example the duration of the gap 525-b is zero. In some examples, the duration of the gap 525-b may be non-zero and may have a pre-determined value. This pre-determined value may be associated with the time a UE takes to reconfigure radio components from a receiving mode to a transmission mode. The duration of the gap 525-b may be limited by the gap threshold to reperform LBT. The duration of the gap 525-b may be for example 16 μs.

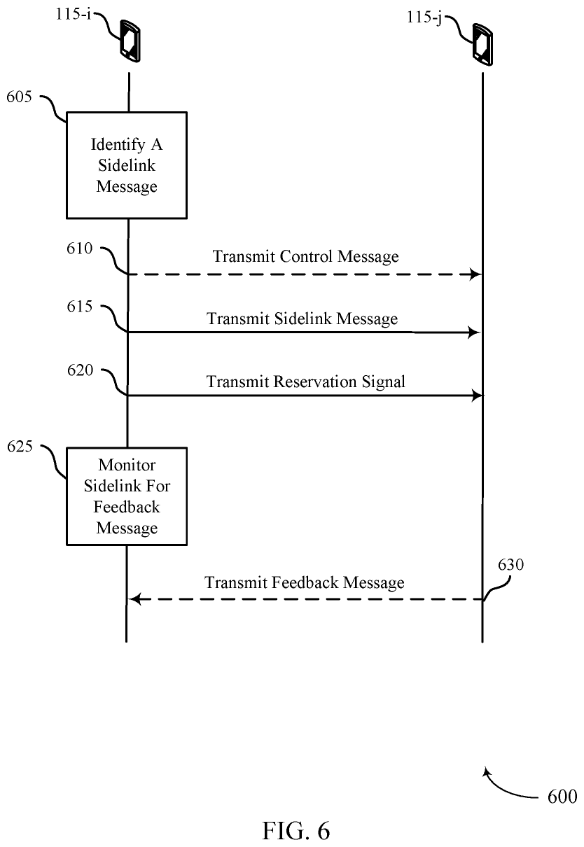

FIG. 6 illustrates an example of a process flow 600 that supports self-contained feedback transmission for sidelink communication in unlicensed spectrum in accordance with aspects of the present disclosure. In some examples, process flow 600 may implement aspects of wireless communications systems 100, 200, or 300.

Process flow 600 illustrates an example of a process by which UE 115-i may transmit a message via sidelink communication in unlicensed spectrum to UE 115-j. UE 115-i and UE 115-j may support self-contained feedback transmission for sidelink communication in unlicensed spectrum in accordance with aspects of the present disclosure.

At 605, UE 115-i may identify a sidelink message scheduled for transmission to UE 115-j via a sidelink communication channel of an unlicensed radio frequency spectrum band.

At 610, UE 115-i may transmit a control message that schedules the sidelink message for transmission to UE 115-j. In some examples, UE 115-i may transmit a control message that schedule multiple consecutive sidelink messages for transmission to UE 115-j. In some examples, UE 115-i may transmit, in the control message, an indication of resources reserved for a reservation signal. In some examples, UE 115-i may transmit, in the control message, an indication to enable the feedback transmission. In some examples, UE 115-i may transmit a control message that schedule multiple consecutive sidelink messages for transmission to UE 115-j.

At 615, UE 115-i may transmit the sidelink message to UE 115-j via the sidelink communications channel of an unlicensed radio frequency spectrum band. In some examples, UE 115-i may perform a contention-based access procedure prior to transmitting the sidelink message to UE 115-j. In some examples, UE 115-i may transmit an indication of the slot configured for feedback with the sidelink message or via a control message that schedules the sidelink message. In some examples, UE 115-i may transmit a sidelink message in multiple slots, where the feedback message is for the sidelink messages transmitted in multiple slots.

At 620, UE 115-i may transmit, after transmitting the sidelink message, a reservation signal to reserve the sidelink communications channel of the unlicensed radio frequency spectrum band for feedback from UE 115-j. In some examples, UE 115-i may transmit the reservation signal over a duration in time between the sidelink message and the feedback message. In some examples, UE 115-i may refrain from transmitting the reservation signal during a gap of the duration, where the gap is less than a gap threshold corresponding to a timing in which a contention-based procedure is to be performed prior to communicating over the sidelink communication channel.

In some examples, at 620, UE 115-i may transmit a reservation signal, where the reservation signal may include transmitting one or more repetitions of the sidelink message over a duration in time between the sidelink message and the feedback message. In some examples, UE 115-i may transmit a reservation signal, where the reservation signal may include transmitting a same TB of the sidelink message and a different redundancy version of the sidelink message over a duration in time between the sidelink message and the feedback message. In some examples, UE 115-i may transmit a reservation signal, where the reservation signal may include transmitting a same TB of the sidelink message and a set of parity bits of the sidelink message over a duration in time between the sidelink message and the feedback message.

In some examples, at 620, UE 115-i may transmit a reservation signal, where the reservation signal may include transmitting a reference signal over a duration in time between the sidelink message and the feedback message. In some examples, the reference signal may be used for channel state measurement, phase tracking, positioning, or a combination thereof. In some examples, at 615, UE 115-i may transmit a reservation signal, where the reservation signal may include transmitting a dummy signal over a duration in time between the sidelink message and the feedback message. In some examples, at 615, UE 115-i may transmit a reservation signal, where the reservation signal may include transmitting the reservation signal via a portion of a slot, or one or more slots, between the sidelink message and the feedback message.

In some examples, at 620, UE 115-i may transmit a reservation signal, where the reservation signal may include transmitting the reservation signal using a set of frequency resources that at least partially overlap frequency resources used for sidelink message, the feedback message, or both.

At 625, UE 115-i may monitor the sidelink communications channel for a feedback message from the second UE after transmitting the reservation signal. In some examples, UE 115-i may receive the feedback message from UE 115-j via the sidelink communications channel.

At 630, UE 115-i may receive the feedback message from UE 115-j. In some examples, UE 115-i may receive the feedback message via a slot configured for feedback, where the slot is configured for feedback with respect to a second slot in which the sidelink message is transmitted.

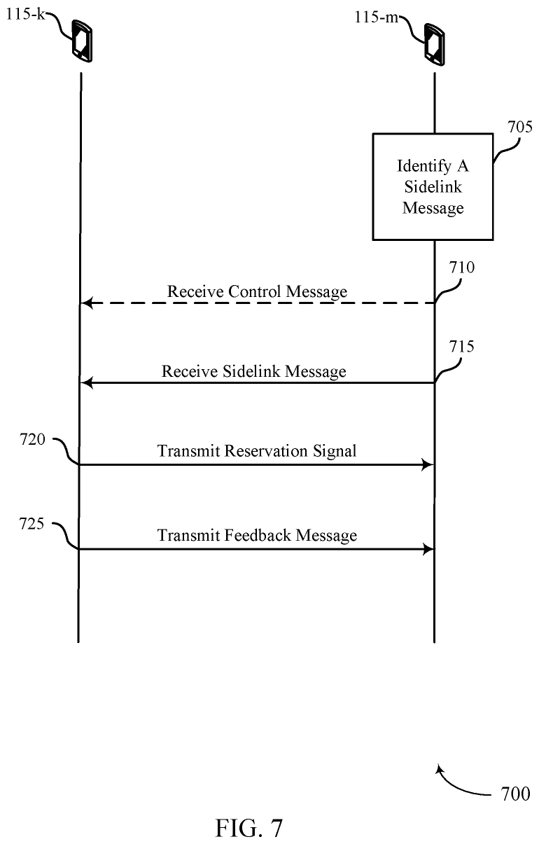

FIG. 7 illustrates an example of a process flow 700 that supports self-contained feedback transmission for sidelink communication in unlicensed spectrum in accordance with aspects of the present disclosure. In some examples, process flow 700 may implement aspects of wireless communications systems 100, 200, or 300.

Process flow 700 illustrates an example of a process by which UE 115-k may transmit a message via sidelink communication in unlicensed spectrum to UE 115-m. UE 115-k and UE 115-m may support self-contained feedback transmission for sidelink communication in unlicensed spectrum in accordance with aspects of the present disclosure.

At 705, UE 115-m may identify a sidelink message scheduled for transmission to UE 115-k via a sidelink communication channel of an unlicensed radio frequency spectrum band.

At 710, UE 115-k may receive a control message from UE 115-m that schedules the sidelink message for transmission to UE 115-k. In some examples, UE 115-k may receive a control message that schedule multiple consecutive sidelink messages for transmission to UE 115-k. In some examples, UE 115-k may receive, in the control message, an indication of resources reserved for a reservation signal. In some examples, UE 115-m may transmit, in the control message, an indication to enable the feedback transmission. In some examples, UE 115-k may receive an indication of the slot configured for feedback via the control message that schedules the sidelink message. In some examples, UE 115-m may transmit a control message that schedule multiple consecutive sidelink messages for transmission to UE 115-m.

At 715, UE 115-k may receive the sidelink message from UE 115-m via the sidelink communications channel of the unlicensed radio frequency spectrum band. In some examples, UE 115-k may receive an indication of the slot configured for feedback with the sidelink message.

At 720, UE 115-k may communicate a reservation signal to reserve the sidelink communications channel of the unlicensed radio frequency spectrum band for feedback from the first UE. In some examples, communicating the reservation signal includes transmitting the reservation signal over a duration in time between the sidelink message and the feedback message. In some examples, UE 115-k may refrain from transmitting the reservation signal during a gap of the duration, where the gap is less than a gap threshold corresponding to a timing in which a contention-based procedure is to be performed prior to communicating over the sidelink communications channel.

In some examples, at 720, UE 115-k may transmit the reservation signal, where the reservation signal includes transmitting control signaling to UE 115-m such as channel state feedback information, channel sensing coordination information, or any combination thereof. In some examples, UE 115-k may transmit the reservation signal, where the reservation signal includes transmitting a reference signal to UE 115-m, where the reservation signal is a reference signal for channel state measurement, phase tracking, positioning, or any combination thereof. In some examples, UE 115-k may transmit the reservation signal, where the reservation signal includes transmitting signaling for AGC training, where the signaling spans one or more symbols. In some examples, UE 115-k may transmit the reservation signal, where the reservation signal includes transmitting a dummy signal to retain the sidelink communication channel. In some examples, UE 115-k may transmit the reservation signal, where the reservation signal includes transmitting the reservation signal using a set of frequency resources that at least partially overlap frequency resources used for the sidelink message, the feedback message, or both.

At 725, UE 115-k may transmit a feedback message to UE 115-m via the sidelink communications channel after communication of the reservation signal. In some examples, UE 115-k may transmit the feedback message via a slot configured for feedback, where the slot is configured for feedback with respect to a second slot in which the sidelink message is received.

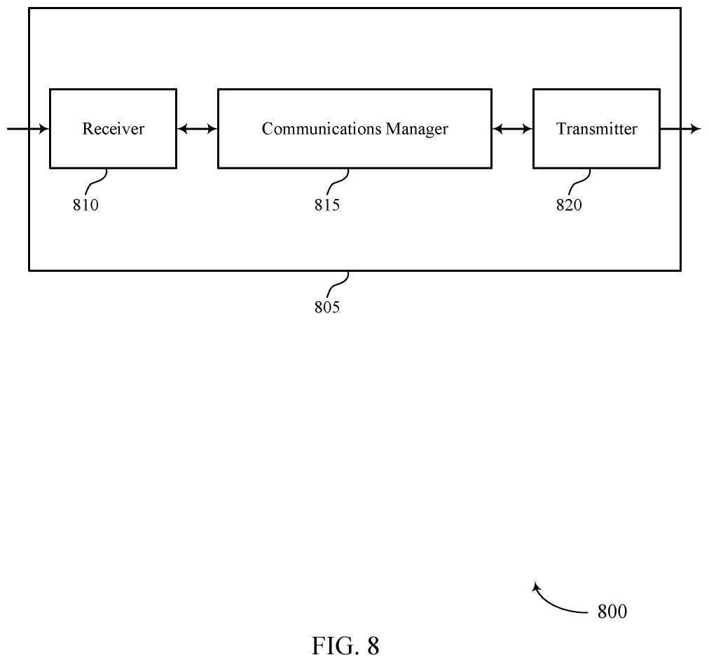

FIG. 8 shows a block diagram 800 of a device 805 that supports self-contained feedback transmission for sidelink communication in unlicensed spectrum in accordance with aspects of the present disclosure. The device 805 may be an example of aspects of a UE 115 as described herein. The device 805 may include a receiver 810, a communications manager 815, and a transmitter 820. The device 805 may also include a processor. Each of these components may be in communication with one another (e.g., via one or more buses).

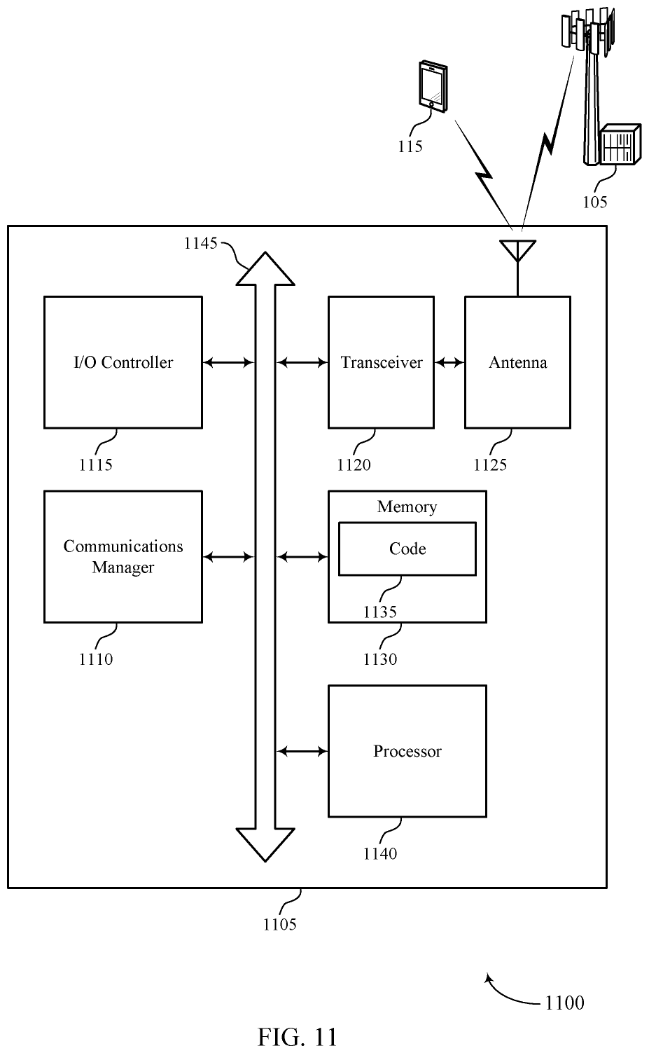

The receiver 810 may receive information such as packets, user data, or control information associated with various information channels (e.g., control channels, data channels, and information related to self-contained feedback transmission for sidelink communication in unlicensed spectrum). Information may be passed on to other components of the device 805. The receiver 810 may be an example of aspects of the transceiver 1120 described with reference to FIG. 11. The receiver 810 may utilize a single antenna or a set of antennas.

The communications manager 815 may identify a sidelink message scheduled for transmission to a second UE via a sidelink communications channel of an unlicensed radio frequency spectrum band, transmit the sidelink message to the second UE via the sidelink communications channel of the unlicensed radio frequency spectrum band, transmit, after transmitting the sidelink message, a reservation signal to reserve the sidelink communications channel of the unlicensed radio frequency spectrum band for feedback from the second UE, and monitor the sidelink communications channel for a feedback message from the second UE after transmitting the reservation signal.

The communications manager 815 may also identify a sidelink message scheduled for transmission by a second UE to the first UE via a sidelink communications channel of an unlicensed radio frequency spectrum band, receive the sidelink message from the second UE via the sidelink communications channel of the unlicensed radio frequency spectrum band, communicate a reservation signal to reserve the sidelink communications channel of the unlicensed radio frequency spectrum band for feedback from the first UE, and transmit a feedback message to the second UE via the sidelink communications channel after communication of the reservation signal. The communications manager 815 may be an example of aspects of the communications manager 1110 described herein.

The communications manager 815, or its sub-components, may be implemented in hardware, code (e.g., software or firmware) executed by a processor, or any combination thereof. If implemented in code executed by a processor, the functions of the communications manager 815, or its sub-components may be executed by a general-purpose processor, a digital signal processor (DSP), an application-specific integrated circuit (ASIC), a field programmable gate array (FPGA) or other programmable logic device, discrete gate or transistor logic, discrete hardware components, or any combination thereof designed to perform the functions described in the present disclosure.

The communications manager 815, or its sub-components, may be physically located at various positions, including being distributed such that portions of functions are implemented at different physical locations by one or more physical components. In some examples, the communications manager 815, or its sub-components, may be a separate and distinct component in accordance with various aspects of the present disclosure. In some examples, the communications manager 815, or its sub-components, may be combined with one or more other hardware components, including but not limited to an input/output (I/O) component, a transceiver, a network server, another computing device, one or more other components described in the present disclosure, or a combination thereof in accordance with various aspects of the present disclosure.

The transmitter 820 may transmit signals generated by other components of the device 805. In some examples, the transmitter 820 may be collocated with a receiver 810 in a transceiver module. For example, the transmitter 820 may be an example of aspects of the transceiver 1120 described with reference to FIG. 11. The transmitter 820 may utilize a single antenna or a set of antennas.

In some examples, the communications manager 815 may be implemented as an integrated circuit or chipset for a mobile device modem, and the receiver 810 and transmitter 820 may be implemented as analog components (e.g., amplifiers, filters, antennas) coupled with the mobile device modem to enable wireless transmission and reception over one or more bands.

The communications manager 815 as described herein may be implemented to realize one or more potential advantages. One implementation may allow the device 805 to provide assistance for maintaining access to a communication channel to transmit a feedback transmission following a data transmission. Communications manager 815 may allow the receiving device to transmit a feedback transmission on the communication channel without performing a LBT procedure.

As such, the device 805 may increase the likelihood of successfully transmitting a feedback transmission, such as HARQ feedback, for sidelink communication in unlicensed spectrum and, accordingly may communicate over the channel with a greater likelihood of success communication. In some examples, based on a greater likelihood of successful communications, the device 805 may more efficiently power a processor or one or more processing units associated with a HARQ feedback procedure and transmitting and receiving communications, which may enable the device to save power, increase battery life, and increase quality of service.

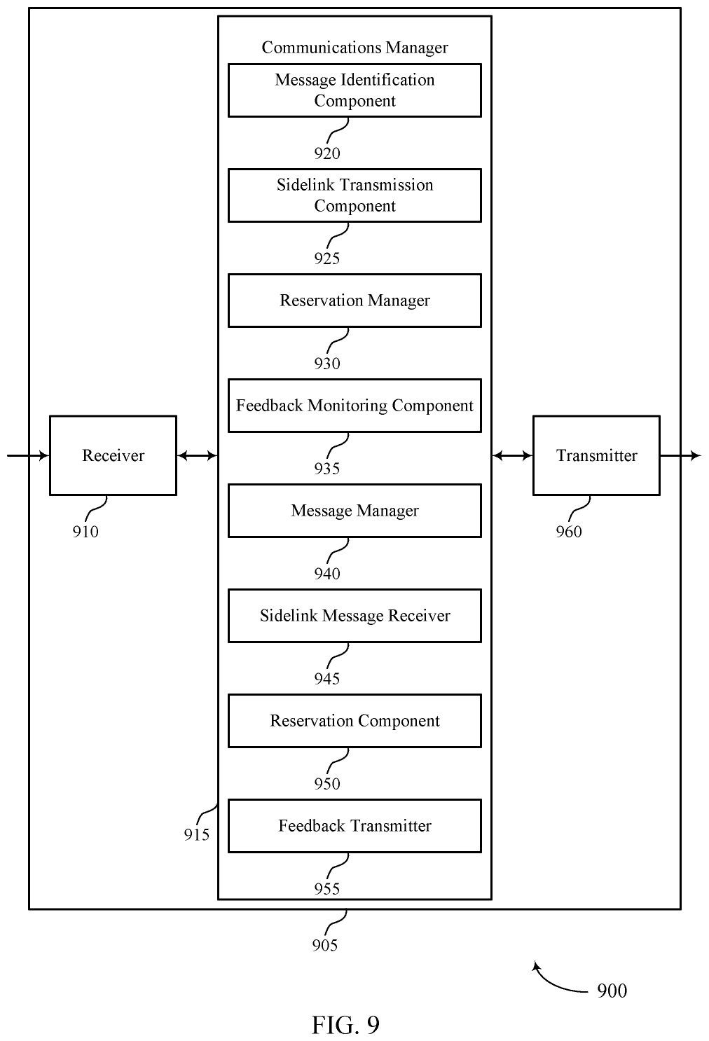

FIG. 9 shows a block diagram 900 of a device 905 that supports self-contained feedback transmission for sidelink communication in unlicensed spectrum in accordance with aspects of the present disclosure. The device 905 may be an example of aspects of a device 805, or a UE 115 as described herein. The device 905 may include a receiver 910, a communications manager 915, and a transmitter 960. The device 905 may also include a processor. Each of these components may be in communication with one another (e.g., via one or more buses).

The receiver 910 may receive information such as packets, user data, or control information associated with various information channels (e.g., control channels, data channels, and information related to self-contained feedback transmission for sidelink communication in unlicensed spectrum). Information may be passed on to other components of the device 905. The receiver 910 may be an example of aspects of the transceiver 1120 described with reference to FIG. 11. The receiver 910 may utilize a single antenna or a set of antennas.

The communications manager 915 may be an example of aspects of the communications manager 815 as described herein. The communications manager 915 may include a message identification component 920, a sidelink transmission component 925, a reservation manager 930, a feedback monitoring component 935, a message manager 940, a sidelink message receiver 945, a reservation component 950, and a feedback transmitter 955. The communications manager 915 may be an example of aspects of the communications manager 1110 described herein.

The message identification component 920 may identify a sidelink message scheduled for transmission to a second UE via a sidelink communications channel of an unlicensed radio frequency spectrum band.

The sidelink transmission component 925 may transmit the sidelink message to the second UE via the sidelink communications channel of the unlicensed radio frequency spectrum band.

The reservation manager 930 may transmit, after transmitting the sidelink message, a reservation signal to reserve the sidelink communications channel of the unlicensed radio frequency spectrum band for feedback from the second UE.

The feedback monitoring component 935 may monitor the sidelink communications channel for a feedback message from the second UE after transmitting the reservation signal.

The message manager 940 may identify a sidelink message scheduled for transmission by a second UE to the first UE via a sidelink communications channel of an unlicensed radio frequency spectrum band.

The sidelink message receiver 945 may receive the sidelink message from the second UE via the sidelink communications channel of the unlicensed radio frequency spectrum band.

The reservation component 950 may communicate a reservation signal to reserve the sidelink communications channel of the unlicensed radio frequency spectrum band for feedback from the first UE.

The feedback transmitter 955 may transmit a feedback message to the second UE via the sidelink communications channel after communication of the reservation signal.

The transmitter 960 may transmit signals generated by other components of the device 905. In some examples, the transmitter 960 may be collocated with a receiver 910 in a transceiver module. For example, the transmitter 960 may be an example of aspects of the transceiver 1120 described with reference to FIG. 11. The transmitter 960 may utilize a single antenna or a set of antennas.

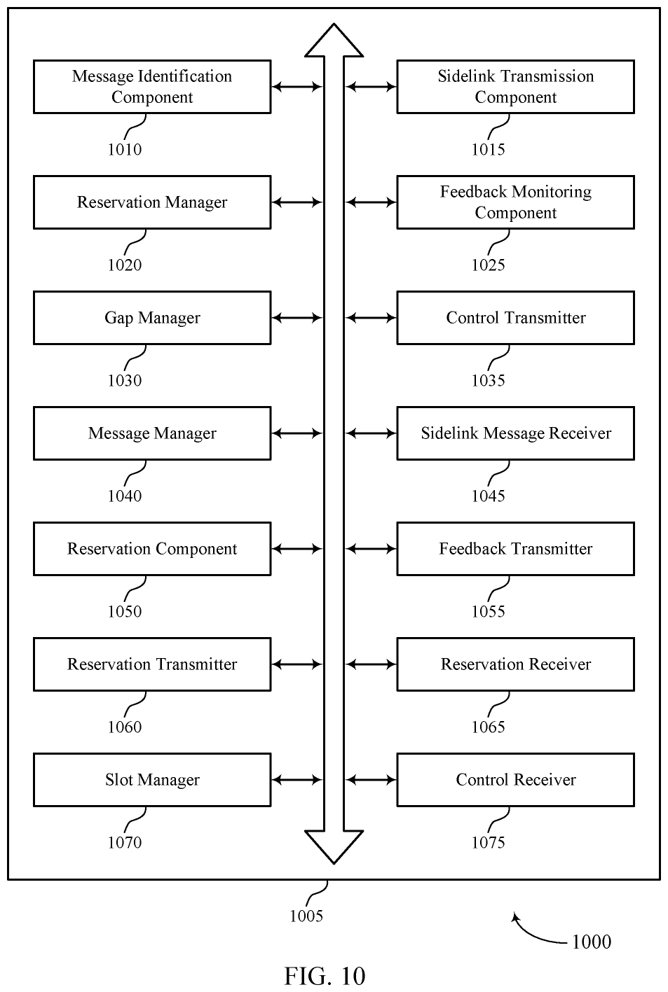

FIG. 10 shows a block diagram 1000 of a communications manager 1005 that supports self-contained feedback transmission for sidelink communication in unlicensed spectrum in accordance with aspects of the present disclosure. The communications manager 1005 may be an example of aspects of a communications manager 815, a communications manager 915, or a communications manager 1110 described herein. The communications manager 1005 may include a message identification component 1010, a sidelink transmission component 1015, a reservation manager 1020, a feedback monitoring component 1025, a gap manager 1030, a control transmitter 1035, a message manager 1040, a sidelink message receiver 1045, a reservation component 1050, a feedback transmitter 1055, a reservation transmitter 1060, a reservation receiver 1065, a slot manager 1070, and a control receiver 1075. Each of these modules may communicate, directly or indirectly, with one another (e.g., via one or more buses).

The message identification component 1010 may identify a sidelink message scheduled for transmission to a second UE via a sidelink communications channel of an unlicensed radio frequency spectrum band.

The sidelink transmission component 1015 may transmit the sidelink message to the second UE via the sidelink communications channel of the unlicensed radio frequency spectrum band.

In some examples, the sidelink transmission component 1015 may transmit an indication of the slot configured for feedback with the sidelink message or via a control message that schedules the sidelink message.

In some examples, the sidelink transmission component 1015 may transmit a sidelink message in multiple slots, where the feedback message is for the sidelink messages transmitted in multiple slots.

The reservation manager 1020 may transmit, after transmitting the sidelink message, a reservation signal to reserve the sidelink communications channel of the unlicensed radio frequency spectrum band for feedback from the second UE.

In some examples, the reservation manager 1020 may transmit the reservation signal over a duration in time between the sidelink message and the feedback message.

In some examples, the reservation manager 1020 may transmit one or more repetitions of the sidelink message over a duration in time between the sidelink message and the feedback message.

In some examples, the reservation manager 1020 may transmit a same TB of the sidelink message and a different redundancy version of the sidelink message over a duration in time between the sidelink message and the feedback message.

In some examples, the reservation manager 1020 may transmit a same TB of the sidelink message and a set of parity bits of the sidelink message over a duration in time between the sidelink message and the feedback message.

In some examples, the reservation manager 1020 may transmit a same TB of the sidelink message and a set of systematic bits of the sidelink message over a duration in time between the sidelink message and the feedback message.

In some examples, the reservation manager 1020 may transmit a reference signal over a duration in time between the sidelink message and the feedback message.

In some examples, the reservation manager 1020 may transmit a dummy signal over a duration in time between the sidelink message and the feedback message.

In some examples, the reservation manager 1020 may transmit the reservation signal via a portion of a slot, or one or more slots, between the sidelink message and the feedback message.

In some examples, the reservation manager 1020 may transmit the reservation signal using a set of frequency resources that at least partially overlap frequency resources used for the sidelink message, the feedback message, or both.

In some cases, the reference signal is for channel state measurement, phase tracking, positioning, or a combination thereof.

The feedback monitoring component 1025 may monitor the sidelink communications channel for a feedback message from the second UE after transmitting the reservation signal.

In some examples, the feedback monitoring component 1025 may receive the feedback message from the second UE via the sidelink communications channel.

In some examples, the feedback monitoring component 1025 may receive the feedback message via a slot configured for feedback, where the slot is configured for feedback with respect to a second slot in which the sidelink message is transmitted.

The message manager 1040 may identify a sidelink message scheduled for transmission by a second UE to the first UE via a sidelink communications channel of an unlicensed radio frequency spectrum band.

The sidelink message receiver 1045 may receive the sidelink message from the second UE via the sidelink communications channel of the unlicensed radio frequency spectrum band.

In some examples, the sidelink message receiver 1045 may receive the sidelink messages in multiple slots, where the feedback message is for the sidelink messages received in multiple slots.

The reservation component 1050 may communicate a reservation signal to reserve the sidelink communications channel of the unlicensed radio frequency spectrum band for feedback from the first UE.

The feedback transmitter 1055 may transmit a feedback message to the second UE via the sidelink communications channel after communication of the reservation signal.

In some examples, the feedback transmitter 1055 may transmit the feedback message via a slot configured for feedback, where the slot is configured for feedback with respect to a second slot in which the sidelink message is received.

The gap manager 1030 may refrain from transmitting the reservation signal during a gap of the duration, where the gap is less than a gap threshold corresponding to a timing in which a contention-based procedure is to be performed prior to communicating over the sidelink communications channel.

The control transmitter 1035 may transmit a control message that schedules the sidelink message for transmission to the second UE.

In some examples, the control transmitter 1035 may transmit, in the control message, an indication of resources reserved for the reservation signal.

In some examples, the control transmitter 1035 may transmit, in the control message, an indication to enable the feedback transmission.

The reservation transmitter 1060 may transmit the reservation signal over a duration in time between the sidelink message and the feedback message.

In some examples, the reservation transmitter 1060 may refrain from transmitting the reservation signal during a gap of the duration, where the gap is less than a gap threshold corresponding to a timing in which a contention-based procedure is to be performed prior to communicating over the sidelink communications channel.

In some examples, transmitting control signaling to the second UE, where the control signaling includes channel state feedback information, channel sensing coordination information, or any combination thereof.

In some examples, the reservation transmitter 1060 may transmit a reference signal to the second UE, where the reservation signal is a reference signal for channel state measurement, phase tracking, positioning, or any combination thereof.

In some examples, the reservation transmitter 1060 may transmit signaling for AGC training, where the signaling spans one or more symbols.

In some examples, the reservation transmitter 1060 may transmit a dummy signal to retain the sidelink communication channel.

In some examples, the reservation transmitter 1060 may transmit the reservation signal using a set of frequency resources that at least partially overlap frequency resources used for the sidelink message, the feedback message, or both.

The reservation receiver 1065 may receive the reservation signal from the second UE, where the reservation signal is a repetition of the sidelink message and the feedback message is based on the repetition of the sidelink message.

In some examples, the reservation receiver 1065 may receive the reservation signal from the second UE, where the reservation signal is a reference signal for channel state measurement, phase tracking, positioning, or any combination thereof.

The slot manager 1070 may receive an indication of the slot configured for feedback with the sidelink message or via a control message that schedules the sidelink message.

The control receiver 1075 may receive a control message that schedules the sidelink message for reception from the second UE.

In some examples, the control receiver 1075 may receive, in the control message, an indication of resources reserved for the reservation signal.

In some examples, the control receiver 1075 may receive, in the control message an indication to enable the feedback transmission.

FIG. 11 shows a diagram of a system 1100 including a device 1105 that supports self-contained feedback transmission for sidelink communication in unlicensed spectrum in accordance with aspects of the present disclosure. The device 1105 may be an example of or include the components of device 805, device 905, or a UE 115 as described herein. The device 1105 may include components for bi-directional voice and data communications including components for transmitting and receiving communications, including a communications manager 1110, an I/O controller 1115, a transceiver 1120, an antenna 1125, memory 1130, and a processor 1140. These components may be in electronic communication via one or more buses (e.g., bus 1145).

The communications manager 1110 may identify a sidelink message scheduled for transmission to a second UE via a sidelink communications channel of an unlicensed radio frequency spectrum band, transmit the sidelink message to the second UE via the sidelink communications channel of the unlicensed radio frequency spectrum band, transmit, after transmitting the sidelink message, a reservation signal to reserve the sidelink communications channel of the unlicensed radio frequency spectrum band for feedback from the second UE, and monitor the sidelink communications channel for a feedback message from the second UE after transmitting the reservation signal. The communications manager 1110 may also identify a sidelink message scheduled for transmission by a second UE to the first UE via a sidelink communications channel of an unlicensed radio frequency spectrum band, receive the sidelink message from the second UE via the sidelink communications channel of the unlicensed radio frequency spectrum band, communicate a reservation signal to reserve the sidelink communications channel of the unlicensed radio frequency spectrum band for feedback from the first UE, and transmit a feedback message to the second UE via the sidelink communications channel after communication of the reservation signal.

The I/O controller 1115 may manage input and output signals for the device 1105. The I/O controller 1115 may also manage peripherals not integrated into the device 1105. In some cases, the I/O controller 1115 may represent a physical connection or port to an external peripheral. In some cases, the I/O controller 1115 may utilize an operating system such as iOS®, ANDROID®, MS-DOS®, MS-WINDOWS®, OS/2®, UNIX®, LINUX®, or another known operating system. In other cases, the I/O controller 1115 may represent or interact with a modem, a keyboard, a mouse, a touchscreen, or a similar device. In some cases, the I/O controller 1115 may be implemented as part of a processor. In some cases, a user may interact with the device 1105 via the I/O controller 1115 or via hardware components controlled by the I/O controller 1115.

The transceiver 1120 may communicate bi-directionally, via one or more antennas, wired, or wireless links as described herein. For example, the transceiver 1120 may represent a wireless transceiver and may communicate bi-directionally with another wireless transceiver. The transceiver 1120 may also include a modem to modulate the packets and provide the modulated packets to the antennas for transmission, and to demodulate packets received from the antennas.

In some cases, the wireless device may include a single antenna 1125. However, in some cases the device may have more than one antenna 1125, which may be capable of concurrently transmitting or receiving multiple wireless transmissions.

The memory 1130 may include random-access memory (RAM) and read-only memory (ROM). The memory 1130 may store computer-readable, computer-executable code 1135 including instructions that, when executed, cause the processor to perform various functions described herein. In some cases, the memory 1130 may contain, among other things, a basic I/O system (BIOS) which may control basic hardware or software operation such as the interaction with peripheral components or devices.

The processor 1140 may include an intelligent hardware device, (e.g., a general-purpose processor, a DSP, a central processing unit (CPU), a microcontroller, an ASIC, an FPGA, a programmable logic device, a discrete gate or transistor logic component, a discrete hardware component, or any combination thereof). In some cases, the processor 1140 may be configured to operate a memory array using a memory controller. In other cases, a memory controller may be integrated into the processor 1140. The processor 1140 may be configured to execute computer-readable instructions stored in a memory (e.g., the memory 1130) to cause the device 1105 to perform various functions (e.g., functions or tasks supporting self-contained feedback transmission for sidelink communication in unlicensed spectrum).

The code 1135 may include instructions to implement aspects of the present disclosure, including instructions to support wireless communications. The code 1135 may be stored in a non-transitory computer-readable medium such as system memory or other type of memory. In some cases, the code 1135 may not be directly executable by the processor 1140 but may cause a computer (e.g., when compiled and executed) to perform functions described herein.

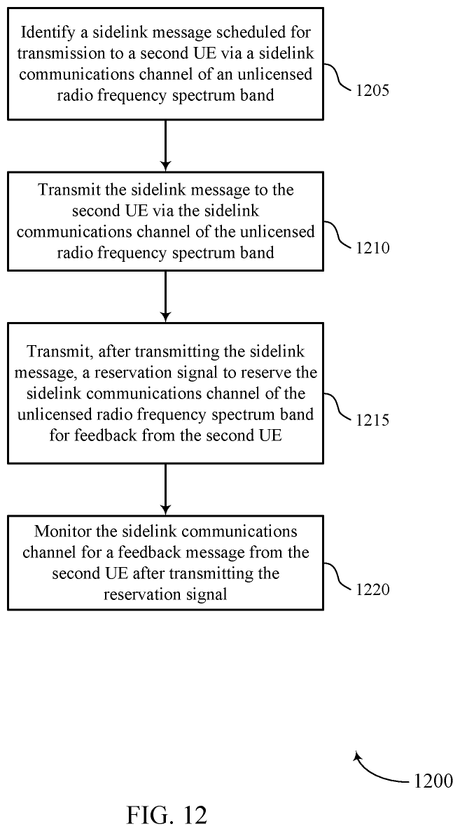

FIG. 12 shows a flowchart illustrating a method 1200 that supports self-contained feedback transmission for sidelink communication in unlicensed spectrum in accordance with aspects of the present disclosure. The operations of method 1200 may be implemented by a UE 115 or its components as described herein. For example, the operations of method 1200 may be performed by a communications manager as described with reference to FIGS. 8 through 11. In some examples, a UE may execute a set of instructions to control the functional elements of the UE to perform the functions described herein. Additionally, or alternatively, a UE may perform aspects of the functions described herein using special-purpose hardware.

At 1205, the UE may identify a sidelink message scheduled for transmission to a second UE via a sidelink communications channel of an unlicensed radio frequency spectrum band. The operations of 1205 may be performed according to the methods described herein. In some examples, aspects of the operations of 1205 may be performed by a message identification component as described with reference to FIGS. 8 through 11.

At 1210, the UE may transmit the sidelink message to the second UE via the sidelink communications channel of the unlicensed radio frequency spectrum band. The operations of 1210 may be performed according to the methods described herein. In some examples, aspects of the operations of 1210 may be performed by a sidelink transmission component as described with reference to FIGS. 8 through 11.

At 1215, the UE may transmit, after transmitting the sidelink message, a reservation signal to reserve the sidelink communications channel of the unlicensed radio frequency spectrum band for feedback from the second UE. The operations of 1215 may be performed according to the methods described herein. In some examples, aspects of the operations of 1215 may be performed by a reservation manager as described with reference to FIGS. 8 through 11.

At 1220, the UE may monitor the sidelink communications channel for a feedback message from the second UE after transmitting the reservation signal. The operations of 1220 may be performed according to the methods described herein. In some examples, aspects of the operations of 1220 may be performed by a feedback monitoring component as described with reference to FIGS. 8 through 11.

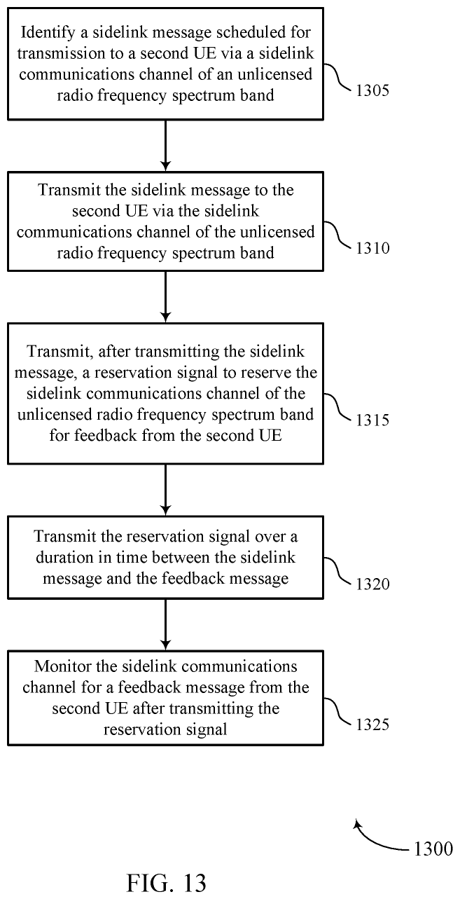

FIG. 13 shows a flowchart illustrating a method 1300 that supports self-contained feedback transmission for sidelink communication in unlicensed spectrum in accordance with aspects of the present disclosure. The operations of method 1300 may be implemented by a UE 115 or its components as described herein. For example, the operations of method 1300 may be performed by a communications manager as described with reference to FIGS. 8 through 11. In some examples, a UE may execute a set of instructions to control the functional elements of the UE to perform the functions described herein. Additionally, or alternatively, a UE may perform aspects of the functions described herein using special-purpose hardware.

At 1305, the UE may identify a sidelink message scheduled for transmission to a second UE via a sidelink communications channel of an unlicensed radio frequency spectrum band. The operations of 1305 may be performed according to the methods described herein. In some examples, aspects of the operations of 1305 may be performed by a message identification component as described with reference to FIGS. 8 through 11.

At 1310, the UE may transmit the sidelink message to the second UE via the sidelink communications channel of the unlicensed radio frequency spectrum band. The operations of 1310 may be performed according to the methods described herein. In some examples, aspects of the operations of 1310 may be performed by a sidelink transmission component as described with reference to FIGS. 8 through 11.

At 1315, the UE may transmit, after transmitting the sidelink message, a reservation signal to reserve the sidelink communications channel of the unlicensed radio frequency spectrum band for feedback from the second UE. The operations of 1315 may be performed according to the methods described herein. In some examples, aspects of the operations of 1315 may be performed by a reservation manager as described with reference to FIGS. 8 through 11.

At 1320, the UE may transmit the reservation signal over a duration in time between the sidelink message and the feedback message. The operations of 1320 may be performed according to the methods described herein. In some examples, aspects of the operations of 1320 may be performed by a reservation manager as described with reference to FIGS. 8 through 11.

At 1325, the UE may monitor the sidelink communications channel for a feedback message from the second UE after transmitting the reservation signal. The operations of 1325 may be performed according to the methods described herein. In some examples, aspects of the operations of 1325 may be performed by a feedback monitoring component as described with reference to FIGS. 8 through 11.

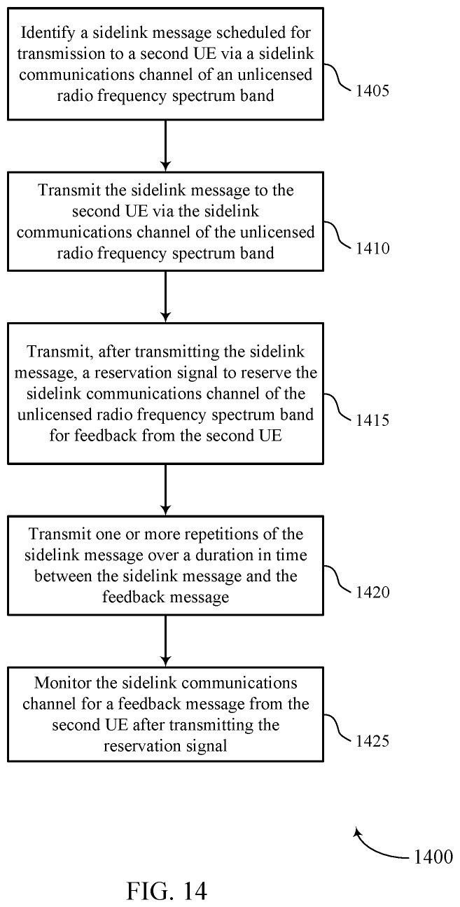

FIG. 14 shows a flowchart illustrating a method 1400 that supports self-contained feedback transmission for sidelink communication in unlicensed spectrum in accordance with aspects of the present disclosure. The operations of method 1400 may be implemented by a UE 115 or its components as described herein. For example, the operations of method 1400 may be performed by a communications manager as described with reference to FIGS. 8 through 11. In some examples, a UE may execute a set of instructions to control the functional elements of the UE to perform the functions described herein. Additionally, or alternatively, a UE may perform aspects of the functions described herein using special-purpose hardware.

At 1405, the UE may identify a sidelink message scheduled for transmission to a second UE via a sidelink communications channel of an unlicensed radio frequency spectrum band. The operations of 1405 may be performed according to the methods described herein. In some examples, aspects of the operations of 1405 may be performed by a message identification component as described with reference to FIGS. 8 through 11.

At 1410, the UE may transmit the sidelink message to the second UE via the sidelink communications channel of the unlicensed radio frequency spectrum band. The operations of 1410 may be performed according to the methods described herein. In some examples, aspects of the operations of 1410 may be performed by a sidelink transmission component as described with reference to FIGS. 8 through 11.

At 1415, the UE may transmit, after transmitting the sidelink message, a reservation signal to reserve the sidelink communications channel of the unlicensed radio frequency spectrum band for feedback from the second UE. The operations of 1415 may be performed according to the methods described herein. In some examples, aspects of the operations of 1415 may be performed by a reservation manager as described with reference to FIGS. 8 through 11.

At 1420, the UE may transmit one or more repetitions of the sidelink message over a duration in time between the sidelink message and the feedback message. The operations of 1420 may be performed according to the methods described herein. In some examples, aspects of the operations of 1420 may be performed by a reservation manager as described with reference to FIGS. 8 through 11.

At 1425, the UE may monitor the sidelink communications channel for a feedback message from the second UE after transmitting the reservation signal. The operations of 1425 may be performed according to the methods described herein. In some examples, aspects of the operations of 1425 may be performed by a feedback monitoring component as described with reference to FIGS. 8 through 11.

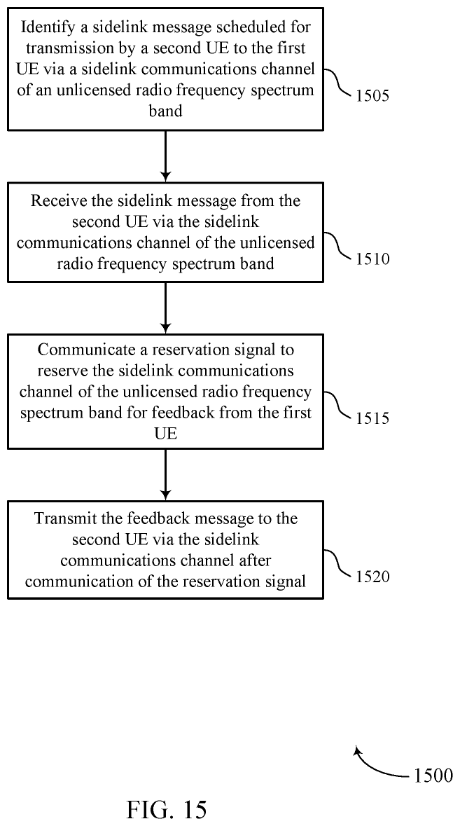

FIG. 15 shows a flowchart illustrating a method 1500 that supports self-contained feedback transmission for sidelink communication in unlicensed spectrum in accordance with aspects of the present disclosure. The operations of method 1500 may be implemented by a UE 115 or its components as described herein. For example, the operations of method 1500 may be performed by a communications manager as described with reference to FIGS. 8 through 11. In some examples, a UE may execute a set of instructions to control the functional elements of the UE to perform the functions described herein. Additionally, or alternatively, a UE may perform aspects of the functions described herein using special-purpose hardware.

At 1505, the UE may identify a sidelink message scheduled for transmission by a second UE to the first UE via a sidelink communications channel of an unlicensed radio frequency spectrum band. The operations of 1505 may be performed according to the methods described herein. In some examples, aspects of the operations of 1505 may be performed by a message manager as described with reference to FIGS. 8 through 11.

At 1510, the UE may receive the sidelink message from the second UE via the sidelink communications channel of the unlicensed radio frequency spectrum band. The operations of 1510 may be performed according to the methods described herein. In some examples, aspects of the operations of 1510 may be performed by a sidelink message receiver as described with reference to FIGS. 8 through 11.

At 1515, the UE may communicate a reservation signal to reserve the sidelink communications channel of the unlicensed radio frequency spectrum band for feedback from the first UE. The operations of 1515 may be performed according to the methods described herein. In some examples, aspects of the operations of 1515 may be performed by a reservation component as described with reference to FIGS. 8 through 11.

At 1520, the UE may transmit a feedback message to the second UE via the sidelink communications channel after communication of the reservation signal. The operations of 1520 may be performed according to the methods described herein. In some examples, aspects of the operations of 1520 may be performed by a feedback transmitter as described with reference to FIGS. 8 through 11.

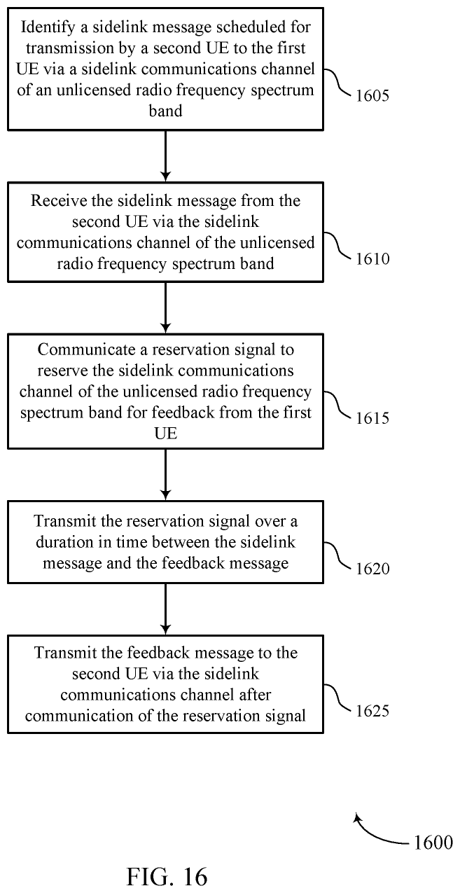

FIG. 16 shows a flowchart illustrating a method 1600 that supports self-contained feedback transmission for sidelink communication in unlicensed spectrum in accordance with aspects of the present disclosure. The operations of method 1600 may be implemented by a UE 115 or its components as described herein. For example, the operations of method 1600 may be performed by a communications manager as described with reference to FIGS. 8 through 11. In some examples, a UE may execute a set of instructions to control the functional elements of the UE to perform the functions described herein. Additionally, or alternatively, a UE may perform aspects of the functions described herein using special-purpose hardware.

At 1605, the UE may identify a sidelink message scheduled for transmission by a second UE to the first UE via a sidelink communications channel of an unlicensed radio frequency spectrum band. The operations of 1605 may be performed according to the methods described herein. In some examples, aspects of the operations of 1605 may be performed by a message manager as described with reference to FIGS. 8 through 11.

At 1610, the UE may receive the sidelink message from the second UE via the sidelink communications channel of the unlicensed radio frequency spectrum band. The operations of 1610 may be performed according to the methods described herein. In some examples, aspects of the operations of 1610 may be performed by a sidelink message receiver as described with reference to FIGS. 8 through 11.

At 1615, the UE may communicate a reservation signal to reserve the sidelink communications channel of the unlicensed radio frequency spectrum band for feedback from the first UE. The operations of 1615 may be performed according to the methods described herein. In some examples, aspects of the operations of 1615 may be performed by a reservation component as described with reference to FIGS. 8 through 11.

At 1620, the UE may transmit the reservation signal over a duration in time between the sidelink message and the feedback message. The operations of 1620 may be performed according to the methods described herein. In some examples, aspects of the operations of 1620 may be performed by a reservation transmitter as described with reference to FIGS. 8 through 11.

At 1625, the UE may transmit a feedback message to the second UE via the sidelink communications channel after communication of the reservation signal. The operations of 1625 may be performed according to the methods described herein. In some examples, aspects of the operations of 1625 may be performed by a feedback transmitter as described with reference to FIGS. 8 through 11.

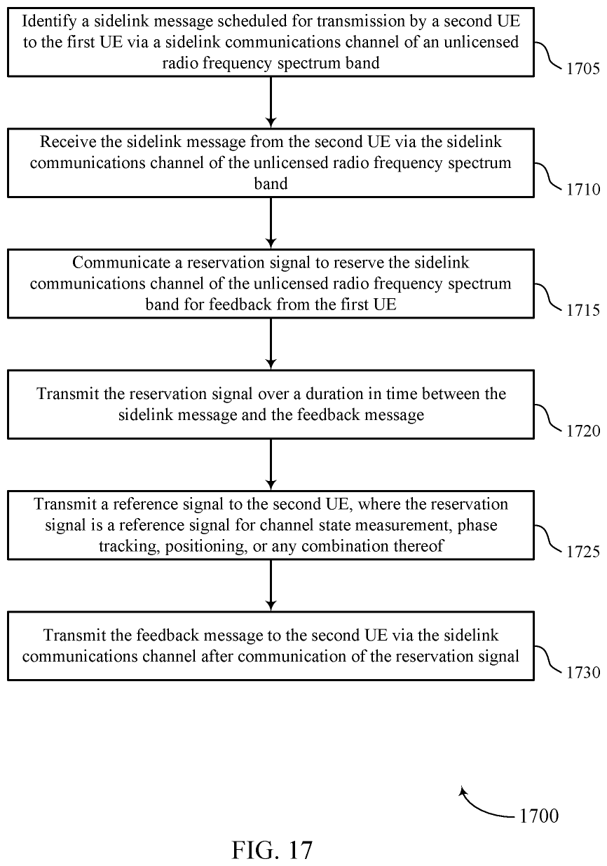

FIG. 17 shows a flowchart illustrating a method 1700 that supports self-contained feedback transmission for sidelink communication in unlicensed spectrum in accordance with aspects of the present disclosure. The operations of method 1700 may be implemented by a UE 115 or its components as described herein. For example, the operations of method 1700 may be performed by a communications manager as described with reference to FIGS. 8 through 11. In some examples, a UE may execute a set of instructions to control the functional elements of the UE to perform the functions described herein. Additionally, or alternatively, a UE may perform aspects of the functions described herein using special-purpose hardware.

At 1705, the UE may identify a sidelink message scheduled for transmission by a second UE to the first UE via a sidelink communications channel of an unlicensed radio frequency spectrum band. The operations of 1705 may be performed according to the methods described herein. In some examples, aspects of the operations of 1705 may be performed by a message manager as described with reference to FIGS. 8 through 11.

At 1710, the UE may receive the sidelink message from the second UE via the sidelink communications channel of the unlicensed radio frequency spectrum band. The operations of 1710 may be performed according to the methods described herein. In some examples, aspects of the operations of 1710 may be performed by a sidelink message receiver as described with reference to FIGS. 8 through 11.

At 1715, the UE may communicate a reservation signal to reserve the sidelink communications channel of the unlicensed radio frequency spectrum band for feedback from the first UE. The operations of 1715 may be performed according to the methods described herein. In some examples, aspects of the operations of 1715 may be performed by a reservation component as described with reference to FIGS. 8 through 11.

At 1720, the UE may transmit the reservation signal over a duration in time between the sidelink message and the feedback message. The operations of 1720 may be performed according to the methods described herein. In some examples, aspects of the operations of 1720 may be performed by a reservation transmitter as described with reference to FIGS. 8 through 11.

At 1725, the UE may transmit a reference signal to the second UE, where the reservation signal is a reference signal for channel state measurement, phase tracking, positioning, or any combination thereof. The operations of 1725 may be performed according to the methods described herein. In some examples, aspects of the operations of 1725 may be performed by a reservation transmitter as described with reference to FIGS. 8 through 11.

At 1730, the UE may transmit a feedback message to the second UE via the sidelink communications channel after communication of the reservation signal. The operations of 1730 may be performed according to the methods described herein. In some examples, aspects of the operations of 1730 may be performed by a feedback transmitter as described with reference to FIGS. 8 through 11.

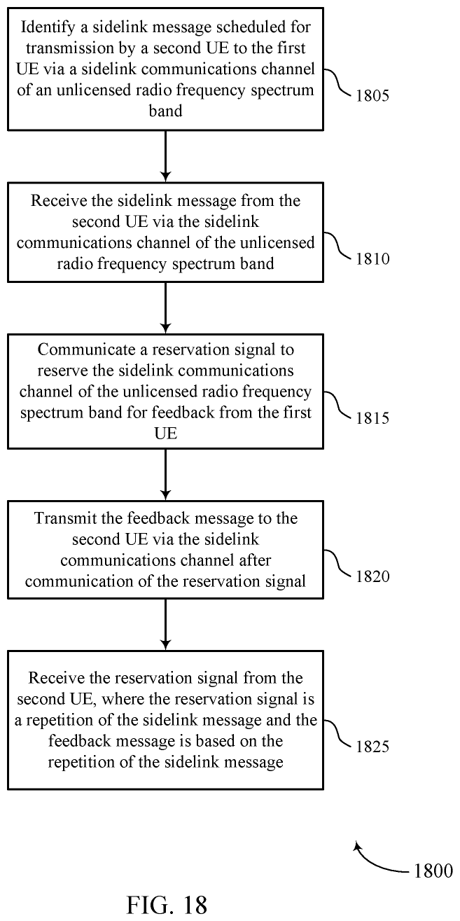

FIG. 18 shows a flowchart illustrating a method 1800 that supports self-contained feedback transmission for sidelink communication in unlicensed spectrum in accordance with aspects of the present disclosure. The operations of method 1800 may be implemented by a UE 115 or its components as described herein. For example, the operations of method 1800 may be performed by a communications manager as described with reference to FIGS. 8 through 11. In some examples, a UE may execute a set of instructions to control the functional elements of the UE to perform the functions described herein. Additionally, or alternatively, a UE may perform aspects of the functions described herein using special-purpose hardware.

At 1805, the UE may identify a sidelink message scheduled for transmission by a second UE to the first UE via a sidelink communications channel of an unlicensed radio frequency spectrum band. The operations of 1805 may be performed according to the methods described herein. In some examples, aspects of the operations of 1805 may be performed by a message manager as described with reference to FIGS. 8 through 11.

At 1810, the UE may receive the sidelink message from the second UE via the sidelink communications channel of the unlicensed radio frequency spectrum band. The operations of 1810 may be performed according to the methods described herein. In some examples, aspects of the operations of 1810 may be performed by a sidelink message receiver as described with reference to FIGS. 8 through 11.

At 1815, the UE may communicate a reservation signal to reserve the sidelink communications channel of the unlicensed radio frequency spectrum band for feedback from the first UE. The operations of 1815 may be performed according to the methods described herein. In some examples, aspects of the operations of 1815 may be performed by a reservation component as described with reference to FIGS. 8 through 11.

At 1820, the UE may transmit a feedback message to the second UE via the sidelink communications channel after communication of the reservation signal. The operations of 1820 may be performed according to the methods described herein. In some examples, aspects of the operations of 1820 may be performed by a feedback transmitter as described with reference to FIGS. 8 through 11.

At 1825, the UE may receive the reservation signal from the second UE, where the reservation signal is a repetition of the sidelink message and the feedback message is based on the repetition of the sidelink message. The operations of 1825 may be performed according to the methods described herein. In some examples, aspects of the operations of 1825 may be performed by a reservation receiver as described with reference to FIGS. 8 through 11.

The following provides an overview of aspects of the present disclosure:

Aspect 1: A method for wireless communications at a first UE, comprising: identifying a sidelink message scheduled for transmission to a second UE via a sidelink communications channel of an unlicensed radio frequency spectrum band; transmitting the sidelink message to the second UE via the sidelink communications channel of the unlicensed radio frequency spectrum band; transmitting, after transmitting the sidelink message, a reservation signal to reserve the sidelink communications channel of the unlicensed radio frequency spectrum band for feedback from the second UE; and monitoring the sidelink communications channel for a feedback message from the second UE after transmitting the reservation signal.

Aspect 2: The method of aspect 1, wherein transmitting the reservation signal comprises: transmitting the reservation signal over a duration in time between the sidelink message and the feedback message.

Aspect 3: The method of aspect 2, further comprising: refraining from transmitting the reservation signal during a gap of the duration, wherein the gap is less than a gap threshold corresponding to a timing in which a contention-based procedure is to be performed prior to communicating over the sidelink communications channel.

Aspect 4: The method of any of aspects 1 through 3, wherein transmitting the reservation signal comprises: transmitting one or more repetitions of the sidelink message over a duration in time between the sidelink message and the feedback message.

Aspect 5: The method of any of aspects 1 through 4, wherein transmitting the reservation signal comprises: transmitting a same TB of the sidelink message and a different redundancy version of the sidelink message over a duration in time between the sidelink message and the feedback message.

Aspect 6: The method of any of aspects 1 through 5, wherein transmitting the reservation signal comprises: transmitting a same TB of the sidelink message and a set of parity bits of the sidelink message over a duration in time between the sidelink message and the feedback message.

Aspect 7: The method of any of aspects 1 through 6, wherein transmitting the reservation signal comprises: transmitting a same TB of the sidelink message and a set of systematic bits of the sidelink message over a duration in time between the sidelink message and the feedback message.

Aspect 8: The method of any of aspects 1 through 7, wherein transmitting the reservation signal comprises: transmitting a reference signal over a duration in time between the sidelink message and the feedback message.

Aspect 9: The method of aspect 8, wherein the reference signal is for channel state measurement, phase tracking, positioning, or a combination thereof.

Aspect 10: The method of any of aspects 1 through 9, wherein transmitting the reservation signal comprises: transmitting the reservation signal via a portion of a slot, or one or more slots, between the sidelink message and the feedback message.

Aspect 11: The method of any of aspects 1 through 10, wherein monitoring the sidelink communications channel comprises: receiving the feedback message from the second UE via the sidelink communications channel.

Aspect 12: The method of aspect 11, wherein receiving the feedback message comprises: receiving the feedback message via a slot configured for feedback, wherein the slot is configured for feedback with respect to a second slot in which the sidelink message is transmitted.

Aspect 13: The method of aspect 12, wherein transmitting the sidelink message comprises: transmitting an indication of the slot configured for feedback with the sidelink message or via a control message that schedules the sidelink message.

Aspect 14: The method of any of aspects 12 through 13, wherein transmitting the sidelink message comprises: transmitting the sidelink message in multiple slots, wherein the feedback message is for the sidelink message transmitted in multiple slots.

Aspect 15: The method of any of aspects 1 through 14, wherein transmitting the reservation signal comprises: transmitting the reservation signal using a set of frequency resources that at least partially overlap frequency resources used for the sidelink message, the feedback message, or both.

Aspect 16: The method of any of aspects 1 through 15, further comprising: transmitting a control message that schedules the sidelink message for transmission to the second UE.

Aspect 17: The method of aspect 16, further comprising: transmitting, in the control message, an indication of resources reserved for the reservation signal.

Aspect 18: The method of any of aspects 16 through 17, further comprising: transmitting, in the control message, an indication to enable the feedback transmission.

Aspect 19: A method for wireless communications at a first UE, comprising: identifying a sidelink message scheduled for transmission by a second UE to the first UE via a sidelink communications channel of an unlicensed radio frequency spectrum band; receiving the sidelink message from the second UE via the sidelink communications channel of the unlicensed radio frequency spectrum band; communicating a reservation signal to reserve the sidelink communications channel of the unlicensed radio frequency spectrum band for feedback from the first UE; and transmitting the feedback message to the second UE via the sidelink communications channel after communication of the reservation signal.

Aspect 20: The method of aspect 19, wherein communicating the reservation signal comprises: transmitting the reservation signal over a duration in time between the sidelink message and the feedback message.

Aspect 21: The method of aspect 20, further comprising: refraining from transmitting the reservation signal during a gap of the duration, wherein the gap is less than a gap threshold corresponding to a timing in which a contention-based procedure is to be performed prior to communicating over the sidelink communications channel.

Aspect 22: The method of any of aspects 20 through 21, wherein transmitting the reservation signal comprises: transmitting control signaling to the second UE, wherein the control signaling comprises channel state feedback information, channel sensing coordination information, or any combination thereof.

Aspect 23: The method of any of aspects 20 through 22, wherein transmitting the reservation signal comprises: transmitting a reference signal to the second UE, wherein the reservation signal is a reference signal for channel state measurement, phase tracking, positioning, or any combination thereof.

Aspect 24: The method of any of aspects 20 through 23, wherein transmitting the reservation signal comprises: transmitting signaling for AGC training, wherein the signaling spans one or more symbols.

Aspect 25: The method of any of aspects 20 through 24, wherein transmitting the reservation signal comprises: transmitting the reservation signal using a set of frequency resources that at least partially overlap frequency resources used for the sidelink message, the feedback message, or both.

Aspect 26: The method of any of aspects 19 through 25, wherein communicating the reservation signal comprises: receiving the reservation signal from the second UE, wherein the reservation signal is a repetition of the sidelink message and the feedback message is based at least in part on the repetition of the sidelink message.

Aspect 27: The method of any of aspects 19 through 26, wherein communicating the reservation signal comprises: receiving the reservation signal from the second UE, wherein the reservation signal is a reference signal for channel state measurement, phase tracking, positioning, or any combination thereof.

Aspect 28: The method of any of aspects 19 through 27, wherein transmitting the feedback message comprises: transmitting the feedback message via a slot configured for feedback, wherein the slot is configured for feedback with respect to a second slot in which the sidelink message is received.

Aspect 29: The method of aspect 28, further comprising: receiving an indication of the slot configured for feedback with the sidelink message or via a control message that schedules the sidelink message.

Aspect 30: The method of any of aspects 19 through 29, wherein receiving the sidelink message comprises: receiving the sidelink messages in multiple slots, wherein the feedback message is for the sidelink message transmitted in multiple slots.

Aspect 31: The method of any of aspects 19 through 30, further comprising: receiving a control message that schedules the sidelink message for reception from the second UE.

Aspect 32: The method of aspect 31, further comprising: receiving, in the control message, an indication of resources reserved for the reservation signal.

Aspect 33: The method of any of aspects 31 through 32, further comprising: receiving, in the control message, an indication to enable the feedback transmission.

Aspect 34: An apparatus for wireless communications at a first UE, comprising a processor; memory coupled with the processor; and instructions stored in the memory and executable by the processor to cause the apparatus to perform a method of any of aspects 1 through 18.

Aspect 35: An apparatus for wireless communications at a first UE, comprising at least one means for performing a method of any of aspects 1 through 18.

Aspect 36: A non-transitory computer-readable medium storing code for wireless communications at a first UE, the code comprising instructions executable by a processor to perform a method of any of aspects 1 through 18.

Aspect 37: An apparatus for wireless communications at a first UE, comprising a processor; memory coupled with the processor; and instructions stored in the memory and executable by the processor to cause the apparatus to perform a method of any of aspects 19 through 33.

Aspect 38: An apparatus for wireless communications at a first UE, comprising at least one means for performing a method of any of aspects 19 through 33.

Aspect 39: A non-transitory computer-readable medium storing code for wireless communications at a first UE, the code comprising instructions executable by a processor to perform a method of any of aspects 19 through 33.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for wireless communications at a first user equipment (UE), comprising:
identifying a sidelink message scheduled for transmission to a second UE via a sidelink communications channel of an unlicensed radio frequency spectrum band;
transmitting the sidelink message to the second UE via the sidelink communications channel of the unlicensed radio frequency spectrum band;
transmitting, after transmitting the sidelink message, a reservation signal to reserve the sidelink communications channel of the unlicensed radio frequency spectrum band for feedback from the second UE; and
monitoring the sidelink communications channel for a feedback message from the second UE after transmitting the reservation signal.

2. The method of claim 1, wherein transmitting the reservation signal comprises:
transmitting the reservation signal over a duration in time between the sidelink message and the feedback message.

3. The method of claim 2, further comprising:
refraining from transmitting the reservation signal during a gap of the duration, wherein the gap is less than a gap threshold corresponding to a timing in which a contention-based procedure is to be performed prior to communicating over the sidelink communications channel.

4. The method of claim 1, wherein transmitting the reservation signal comprises:
transmitting one or more repetitions of the sidelink message over a duration in time between the sidelink message and the feedback message.

5. The method of claim 1, wherein transmitting the reservation signal comprises:
transmitting a same transport block of the sidelink message and a different redundancy version of the sidelink message over a duration in time between the sidelink message and the feedback message.

6. The method of claim 1, wherein transmitting the reservation signal comprises:
transmitting a same transport block of the sidelink message and a set of parity bits of the sidelink message over a duration in time between the sidelink message and the feedback message.

7. The method of claim 1, wherein transmitting the reservation signal comprises:
transmitting a same transport block of the sidelink message and a set of systematic bits of the sidelink message over a duration in time between the sidelink message and the feedback message.

8. The method of claim 1, wherein transmitting the reservation signal comprises:
transmitting a reference signal over a duration in time between the sidelink message and the feedback message.

9. The method of claim 8, wherein the reference signal is for channel state measurement, phase tracking, positioning, or a combination thereof.

10. The method of claim 1, wherein transmitting the reservation signal comprises:
transmitting the reservation signal via a portion of a slot, or one or more slots, between the sidelink message and the feedback message.

11. The method of claim 1, wherein monitoring the sidelink communications channel comprises:
receiving the feedback message from the second UE via the sidelink communications channel.

12. The method of claim 11, wherein receiving the feedback message comprises:
receiving the feedback message via a slot configured for feedback, wherein the slot is configured for feedback with respect to a second slot in which the sidelink message is transmitted.

13. The method of claim 12, wherein transmitting the sidelink message comprises:
transmitting an indication of the slot configured for feedback with the sidelink message or via a control message that schedules the sidelink message.

14. The method of claim 12, wherein transmitting the sidelink message comprises:
transmitting the sidelink message in multiple slots, wherein the feedback message is for the sidelink message transmitted in multiple slots.

15. The method of claim 1, wherein transmitting the reservation signal comprises:
transmitting the reservation signal using a set of frequency resources that at least partially overlap frequency resources used for the sidelink message, the feedback message, or both.

16. The method of claim 1, further comprising:
transmitting a control message that schedules the sidelink message for transmission to the second UE.

17. A method for wireless communications at a first user equipment (UE), comprising:
identifying a sidelink message scheduled for transmission by a second UE to the first UE via a sidelink communications channel of an unlicensed radio frequency spectrum band;
receiving the sidelink message from the second UE via the sidelink communications channel of the unlicensed radio frequency spectrum band;
communicating a reservation signal to reserve the sidelink communications channel of the unlicensed radio frequency spectrum band for feedback from the first UE; and
transmitting a feedback message to the second UE via the sidelink communications channel after communication of the reservation signal.

18. The method of claim 17, wherein communicating the reservation signal comprises:
transmitting the reservation signal over a duration in time between the sidelink message and the feedback message.

19. The method of claim 18, further comprising:
refraining from transmitting the reservation signal during a gap of the duration, wherein the gap is less than a gap threshold corresponding to a timing in which a contention-based procedure is to be performed prior to communicating over the sidelink communications channel.

20. The method of claim 18, wherein transmitting the reservation signal comprises:
transmitting control signaling to the second UE, wherein the control signaling comprises channel state feedback information, channel sensing coordination information, or any combination thereof.

21. The method of claim 18, wherein transmitting the reservation signal comprises:
transmitting a reference signal to the second UE, wherein the reservation signal is a reference signal for channel state measurement, phase tracking, positioning, or any combination thereof.

22. The method of claim 18, wherein transmitting the reservation signal comprises:
transmitting signaling for automatic gain control training, wherein the signaling spans one or more symbols.

23. The method of claim 18, wherein transmitting the reservation signal comprises:
transmitting the reservation signal using a set of frequency resources that at least partially overlap frequency resources used for the sidelink message, the feedback message, or both.

24. The method of claim 17, wherein communicating the reservation signal comprises:
receiving the reservation signal from the second UE, wherein the reservation signal is a repetition of the sidelink message and the feedback message is based at least in part on the repetition of the sidelink message.

25. The method of claim 17, wherein communicating the reservation signal comprises:
receiving the reservation signal from the second UE, wherein the reservation signal is a reference signal for channel state measurement, phase tracking, positioning, or any combination thereof.

26. The method of claim 17, wherein transmitting the feedback message comprises:
transmitting the feedback message via a slot configured for feedback, wherein the slot is configured for feedback with respect to a second slot in which the sidelink message is received.

27. The method of claim 17, wherein receiving the sidelink message comprises:
receiving the sidelink messages in multiple slots, wherein the feedback message is for the sidelink message transmitted in multiple slots.

28. The method of claim 17, further comprising:
receiving a control message that schedules the sidelink message for reception from the second UE.

29. An apparatus for wireless communications at a first user equipment (UE), comprising:
a processor,
memory coupled with the processor; and
instructions stored in the memory and executable by the processor to cause the apparatus to:
identify a sidelink message scheduled for transmission to a second UE via a sidelink communications channel of an unlicensed radio frequency spectrum band;
transmit the sidelink message to the second UE via the sidelink communications channel of the unlicensed radio frequency spectrum band;
transmit, after transmitting the sidelink message, a reservation signal to reserve the sidelink communications channel of the unlicensed radio frequency spectrum band for feedback from the second UE; and
monitor the sidelink communications channel for a feedback message from the second UE after transmitting the reservation signal.

30. An apparatus for wireless communications at a first user equipment (UE), comprising:
a processor,
memory coupled with the processor; and
instructions stored in the memory and executable by the processor to cause the apparatus to:
identify a sidelink message scheduled for transmission by a second UE to the first UE via a sidelink communications channel of an unlicensed radio frequency spectrum band;
receive the sidelink message from the second UE via the sidelink communications channel of the unlicensed radio frequency spectrum band;
communicate a reservation signal to reserve the sidelink communications channel of the unlicensed radio frequency spectrum band for feedback from the first UE; and
transmit the feedback message to the second UE via the sidelink communications channel after communication of the reservation signal.
